(19) United States
(12) Patent Application Publication
(10) Pub. No.: US 2023/0315094 A1
(43) Pub. Date: Oct. 5, 2023

(54) METHOD, APPARATUS AND COMPUTER PROGRAM FOR PROVIDING AUGMENTED REALITY GUIDANCE FOR AERIAL VEHICLE

(71) Applicant: THINKWARE CORPORATION, Seongnam-si (KR)

(72) Inventors: Yo Sep Park, Seongnam-si (KR); Suk Pil Ko, Seongnam-si (KR); Shin Hyoung Kim, Seongnam-si (KR)

(73) Assignee: THINKWARE CORPORATION, Seongnam-si (KR)

(21) Appl. No.: 18/107,676

(22) Filed: Feb. 9, 2023

(30) Foreign Application Priority Data
Feb. 9, 2022 (KR) 10-2022-0016957
Feb. 9, 2023 (KR) 10-2023-0017634

(51) Int. Cl. G05D 1/00; G05D 1/10

(52) U.S. Cl. CPC G05D 1/0088; G05D 1/106; G05D 1/104

(57) ABSTRACT

Disclosed is a method of providing augmented reality guidance for an aerial vehicle. A method of providing augmented reality guidance for an aerial vehicle includes acquiring an aerial vehicle flight image captured through a camera installed in the aerial vehicle, acquiring a flight route for a flight to a destination of the aerial vehicle, generating an augmented reality (AR) route guidance object corresponding to the flight route, generating an AR route guidance image by mapping the generated AR route guidance object to the aerial vehicle flight image, and displaying the generated AR route guidance image.

### BACKGROUND

### 1. Field

The technical idea of the present disclosure relates to a method, an apparatus, and a computer program for providing augmented reality guidance for an aerial vehicle, and a computer-readable recording medium including a program code for executing the method of providing augmented reality guidance for an aerial vehicle.

### 2. Description of Related Art

Urban air mobility (UAM) may be a next-generation mobility solution that maximizes mobility efficiency in the urban area, and has emerged to solve the rapid increase in social costs or the like such as reduced movement efficiency and logistics transportation costs due to congested traffic jam in the urban area.

In modern times where long-distance travel time has increased and traffic jam has worsened, the UAM solving these problems is considered a future innovation business.

The operation of the initial UAM used a new airframe type certified for flight in the current operating regulations and environment. For the introduction of the UAM operations, innovations in related regulations and UAM dedicated flight corridors may be introduced. New operating regulations and infrastructure enable highly autonomous traffic management.

Due to the increase in ground traffic every year, the time required for travel becomes longer, resulting in considerable economic cost loss. As a concept of city-centered air transportation that has been continuously discussed for this purpose, the limitations of the existing helicopter-type transportation have not been resolved, and as a result, high costs of operation and customer service and negative public perceptions of noise and pollution have hampered significant market growth.

This has led to the search for alternative transportation means, and the evolution of modern technology has made it possible to support the development of the concept of the UAM. In this sense, the introduction of the concept of the UAM suggests a new approach to alternative air transportation means in the urban area.

The UAM aerial vehicle is generally transportation means that constructs a next-generation advanced transportation system that safely and conveniently transports people and cargo in the urban environment based on electric power, low-noise aircraft, and a vertical take-off and landing pad. The reason why the above-described low noise and vertical take-off and landing should be premised is to increase the movement efficiency when operated in the urban area.

Due to the activation and commercialization of such unmanned aerial vehicle, the demand for effective control and management of the unmanned aerial vehicle is increasing. To this end, it is necessary to visualize a flight route of the unmanned aerial vehicle in order to allow the unmanned aerial vehicle to fly or to effectively manage the route of the unmanned aerial vehicles in flight.

In general, the currently commercialized aerial vehicle provides a route guidance service to a pilot by a method of providing the flight route and operational information through a multi-function display installed in the aerial vehicle, but since this conventional method simply displays route information between a departure point and a destination numerically or in a radar form, the conventional method has a problem in that only experienced pilots may acquire the information and the pilots may not confirm in real time the presence or absence of hazards for the external environment in relation to the aircraft operation.

In addition, while the UAM aerial vehicle flying in the urban environment having a low flight altitude is frequently exposed to dangerous objects (electric wires, birds, buildings, etc.), the pilot may only confirm a front view, so it is difficult to detect dangerous objects located on or approaching a rear surface, a side surface, or the like of the unmanned aerial vehicle.

Therefore, for the commercialization and stable flight of the UAM aerial vehicle, it is necessary to visualize a flight route on a 3D map for an intuitive and effective visualization of the flight route, and it is necessary to visualize various factors, such as whether flight is permitted, route setting, detection of ground buildings, and detection of dangerous objects, along with the flight route.

Also, in the related art, there is no user-friendly navigation for the aerial vehicle. Recently, as technology for the UAM is being developed, it is expected that the user-friendly navigation will be required as the UAM is activated.

In addition, there was a problem that it is difficult to visually (intuitively) identify the designated route which is the conventional aerial vehicle display method. Therefore, it is expected that it will be difficult to travel a first route when the UAM is activated later or the route becomes complicated.

### SUMMARY

Accordingly, an object of the present disclosure is to solve the above problems.

The present disclosure is to provide a 3-dimensional (3D) stereoscopic route so that a pilot may visually receive route guidance when using UAM.

The present disclosure is to provide is to provide real-time information on a degree of deviation from a prohibited area or a designated route.

The present disclosure is to provide is to provide guidance so that a first route may be traveled immediately.

The present disclosure is to provide a guidance route based on GPS even in bad weather.

In an aspect of the present disclosure, a method of providing augmented reality guidance for an aerial vehicle includes: acquiring an aerial vehicle flight image captured through a camera installed in the aerial vehicle; acquiring a flight route for a flight to a destination of the aerial vehicle; generating an augmented reality (AR) route guidance object corresponding to the flight route; generating an AR route guidance image by mapping the generated AR route guidance object to the aerial vehicle flight image; and displaying the generated AR route guidance image.

The acquiring of the aerial vehicle flight image may include: calculating a tilt direction slope value during the flight of the aerial vehicle; and correcting a tilt direction slope of the camera so that the camera keeps level based on the calculated slope value.

The AR route guidance image may further include an object indicating a slope of the aerial vehicle in yaw, pitch, and roll directions.

The method may further include: comparing a location of the aerial vehicle with the flight route to determine whether the aerial vehicle deviates from the route, in which, in the displaying, the AR route guidance object may be displayed differently depending on whether the aerial vehicle deviates from the route.

The method may further include: calculating a degree of the deviation from the route when the aerial vehicle deviates from the route, in which, in the displaying, the AR route guidance object is displayed differently depending on the degree of the deviation from the route.

The method may further include: determining a risk of the flight route based on dynamic hazard information mapped to flight map data of the aerial vehicle, in which the dynamic hazard information may include at least one of weather information, bird flock information, and other aerial vehicles information.

The method may further include: determining a risk level by applying a weight to the hazard information, in which, in the displaying, the AR route guidance object may be displayed differently depending on the risk level.

The AR route guidance object may be displayed differently by adjusting at least one of color and transparency of the AR route guidance object.

The method may further include, when an altitude of the aerial vehicle is out of a reference altitude range, generating an AR altitude danger guidance object indicating altitude danger, in which, in the displaying, the generated AR altitude danger guidance object may be displayed on the AR route guidance image.

The method may further include, when an event is detected from the aerial vehicle flight image during the flight of the aerial vehicle, identifying a type of the event, in which, in the displaying, an AR event guidance object indicating the event according to the identified type of the event may be displayed on the AR route guidance image.

The event may include at least one of a bird flock event, a collision risk building, a vertiport, and a prohibited area.

In the generating of the AR route guidance object, an AR route guidance object composed of a plurality of objects may be generated, and the AR route guidance object may be generated by adjusting an arrangement interval of the plurality of objects according to whether the route is a curve route or a straight route.

The generating of the AR route guidance object may include: calculating an image distance to a point where the plurality of objects are displayed based on a viewpoint of the aerial vehicle; and adjusting vertical heights of each of the plurality of objects according to the calculated image distance.

The AR route guidance image may include at least one of a first AR route guidance image displaying the AR route guidance object on a forward image that is transmitted through a windshield of the aerial vehicle and shown to a passenger, and a second AR route guidance image displaying the AR route guidance object in the captured aerial vehicle flight image shown to the passenger through a screen.

A program stored in a computer-readable recording medium including a program code for executing the method of providing augmented reality guidance described above.

A computer-readable recording medium in which a program for executing the method of providing augmented reality guidance described above is recorded.

In another aspect of the present disclosure, an apparatus for providing augmented reality guidance includes: an image acquisition unit installed in an aerial vehicle to acquire a flight image of the aerial vehicle; a flight route determination unit generating a flight route for a flight to a destination of the aerial vehicle; an AR guidance object generating unit generating an augmented reality (AR) route guidance object corresponding to the flight route; an AR guidance image generation unit generating an AR route guidance image by mapping the generated AR route guidance object to the aerial vehicle flight image; and a display unit displaying the generated AR route guidance image.

The apparatus may further include: a slope correction unit calculating a tilt direction slope value during the flight of the aerial vehicle and correcting the tilt direction slope value of the camera to keep the camera unit level based on the calculated slope value.

The AR route guidance image may further include an object indicating a slope of the aerial vehicle in yaw, pitch, and roll directions.

The flight route determination unit may compare a location of the aerial vehicle with the flight route to determine whether the aerial vehicle deviates from the route, and the display unit may display the AR route guidance object differently depending on whether the aerial vehicle deviates from the route.

The flight route determination unit may calculate a degree of the deviation from the route when the aerial vehicle deviates from the route, and the display unit may display the AR route guidance object differently depending on the degree of the deviation from the route.

The flight route determination unit may determine the risk of the flight route based on dynamic hazard information mapped to flight map data of the aerial vehicle, and the dynamic hazard information may include at least one of weather information, bird flock information, and other aerial vehicles information.

The flight route determination unit may determine a risk level by applying a weight to the hazard information, and the display unit may display the AR route guidance object differently depending on the risk level.

The AR route guidance object may be displayed differently by adjusting at least one of color and transparency.

The AR guidance object generation unit may generate an AR altitude danger guidance object indicating altitude danger when an altitude of the aerial vehicle is out of a reference altitude range, and the display unit displays the generated AR altitude danger guidance object on the AR route guidance image.

The apparatus may further include, when an event is detected from the aerial vehicle flight image during the flight of the aerial vehicle, an event identification unit identifies a type of the event, in which the display unit may display an AR event guidance object indicating the event according to the identified type of the event on the AR route guidance image.

The event may include at least one of a bird flock event, a collision risk building, a vertiport, and a prohibited area.

The AR guidance object generation unit may generate an AR route guidance object composed of a plurality of objects, and generate the AR route guidance object by adjusting an arrangement interval of the plurality of objects according to whether the route is a curve route or a straight route.

The AR guidance object generation unit may calculate an image distance to a point where the plurality of objects are displayed based on the viewpoint of the aerial vehicle, and adjust vertical heights of each of the plurality of objects according to the calculated image distance.

The AR route guidance image may include at least one of a first AR route guidance image displaying the AR route guidance object on a forward image that is transmitted through a windshield of the aerial vehicle and shown to a passenger, and a second AR route guidance image displaying the AR route guidance object in the captured aerial vehicle flight image shown to the passenger through a screen.

Each feature of the above-described embodiments may be implemented in combination in other embodiments unless inconsistent with or exclusive of the other embodiments.

### BRIEF DESCRIPTION OF DRAWINGS

FIG. 1 is a diagram illustrating a conceptual architecture of UAM according to an embodiment of the present disclosure.

FIG. 2 is a diagram for describing an ecosystem of the UAM according to the embodiment of the present disclosure.

FIG. 3 is a diagram for describing locations of tracks and aerodromes flying by a UAM aerial vehicle in a flight corridor of the UAM according to the embodiment of the present disclosure.

FIGS. 4 and 5 are diagrams illustrating the UAM flight corridor according to the embodiment of the present disclosure.

FIG. 6 is a diagram illustrating the flight corridor of UAM for a point to point connection according to an embodiment of the present disclosure.

FIG. 7 is a diagram illustrating a development stage of an operating technology level of the UAM.

FIG. 8 is a diagram illustrating a flight mode of aerial vehicle according to an exemplary embodiment of the present disclosure.

FIG. 9 is a block diagram illustrating a configuration of an apparatus for providing augmented reality guidance for an aerial vehicle according to an embodiment of the present disclosure.

FIG. 10 is a diagram illustrating a hazard according to an embodiment of the present disclosure.

FIG. 11 is a diagram illustrating a flow of generating an augmented reality guidance screen of an aerial vehicle according to an embodiment of the present disclosure and displaying the generated augmented reality guidance screen on a screen.

FIG. 12 is a diagram illustrating a configuration of a method of providing augmented reality guidance for an aerial vehicle according to an embodiment of the present disclosure.

FIGS. 13 to 15 are diagrams illustrating an example of a camera tilt correction according to an embodiment of the present disclosure.

FIG. 16 is a diagram illustrating an example of AR route risk guidance according to an embodiment of the present disclosure.

FIGS. 17 to 21 are diagrams illustrating an example of AR altitude deviation guidance according to an embodiment of the present disclosure.

FIG. 22 is a diagram illustrating an example of AR event guidance according to an embodiment of the present disclosure.

FIGS. 23 to 27 are diagrams illustrating an example of AR route deviation guidance according to an embodiment of the present disclosure.

FIGS. 28 to 32 are diagrams illustrating a method of displaying an AR route guidance object according to an embodiment of the present disclosure.

FIGS. 33 to 37 are diagrams illustrating a method of displaying an AR screen according to a second embodiment of the present disclosure.

FIGS. 38 and 39 are diagrams illustrating a method of displaying an AR screen according to a third embodiment of the present disclosure.

FIGS. 40 to 44 is diagrams illustrating AR guidance objects displayed during taking off and landing of a UAM aerial vehicle according to a fourth embodiment of the present disclosure.

FIG. 45 is a diagram illustrating a secondary flight display of FIG. 44.

FIGS. 46 and 47 are diagrams illustrating a landing guidance screen of a surround view monitor method according to the fourth embodiment of the present disclosure.

FIGS. 48 to 58 are diagrams illustrating a method of displaying a UAM flight-related event guidance object according to the fourth embodiment of the present disclosure.

FIGS. 59 to 63 are diagrams illustrating AR guidance objects displayed during taking off and landing of a UAM aerial vehicle according to a fifth embodiment of the present disclosure.

FIGS. 64 and 65 are diagrams illustrating a landing guidance screen of a surround view monitor method according to the fifth embodiment of the present disclosure.

FIGS. 66 to 71 are diagrams illustrating a method of displaying a UAM flight-related event guidance object according to the fifth embodiment of the present disclosure.

FIG. 72 is a diagram illustrating AR guidance objects displayed during flight of a UAM aerial vehicle according to a sixth embodiment of the present disclosure.

FIG. 73 is a block diagram illustrating an aerial vehicle according to an embodiment of the present disclosure.

### DETAILED DESCRIPTION

Hereinafter, detailed embodiments of the present disclosure will be described with reference to the accompanying drawings. The following detailed descriptions are provided to help a comprehensive understanding of methods, devices and/or systems described herein. However, the embodiments are described by way of examples only and the present disclosure is not limited thereto.

In describing the embodiments of the present disclosure, when a detailed description of well-known technology relating to the present disclosure may unnecessarily make unclear the spirit of the present disclosure, a detailed description thereof will be omitted. Further, the following terminologies are defined in consideration of the functions in the present disclosure and may be construed in different ways by the intention of users and operators. Therefore, the definitions thereof should be construed based on the contents throughout the specification. The terms used in the detailed description is merely for describing the embodiments of the present disclosure and should in no way be limited. Unless clearly used otherwise, an expression in the singular form includes the meaning of the plural form. In this description, expressions such as “including” or “comprising” are intended to indicate certain characteristics, numbers, steps, operations, elements, some or combinations thereof, and it should not be interpreted to exclude the existence or possibility of one or more other characteristics, numbers, steps, operations, elements, parts or combinations thereof other than those described.

In addition, terms ‘first’, ‘second’, A, B, (a), (b), and the like, will be used in describing components of embodiments of the present disclosure. These terms are used only in order to distinguish any component from other components, and features, sequences, or the like, of corresponding components are not limited by these terms.

Urban air mobility (UAM) used throughout this specification comprehensively refers to an urban transportation system that transports people and cargo using aircraft rather than ground transportation means. An airframe applied to a UAM operation may include a fixed-wing aircraft and personal air vehicle (PAV) type capable of horizontal take-off and landing, also known as vertical take-off and landing (VTOL) or conventional take-off and landing (CTOL).

More specifically, the urban air mobility (UAM) enables highly automated, passenger- and cargo-transporting air transport services in and around the urban area.

Urban air traffic is an aggregation of advanced air mobility (AAM) being developed by governments and industries. The AAM enables transportation of people and cargo in regional, local, international and urban environments. Among those, the UAM is being operated to suit movement in the urban area.

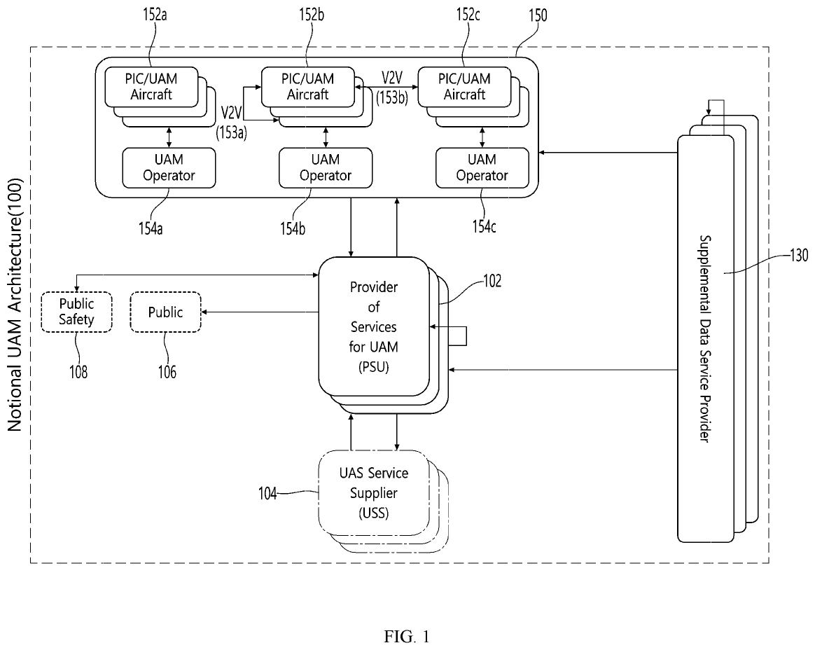

FIG. 1 is a diagram illustrating a conceptual architecture of UAM according to an embodiment of the present disclosure. Hereinafter, referring to FIG. 1, a conceptual architecture 100 of UAM that may be defined in an environment for UAM operation management will be described.

First, terms generally used in this specification will be defined to help understanding of the present disclosure.

A UAM aerodrome refers to a location where a UAM flight operation departs and arrives, a UAM aerial vehicle refers to aircraft capable of performing a UAM operation, a UAM flight corridor is a three-dimensional airspace with performance requirements for operating at a location where tactical air traffic control (ATC) separation services are not provided or are crossed, and an airspace assigned for flight of a UAM aerial vehicle to prevent collisions between a non-UAM aerial vehicle and the UAM aerial vehicle.

The UAM operation refers to transporting passengers and/or cargo from a UAM aerodrome at any one location to a UAM aerodrome at another location.

The UAM operation information includes, but not limited thereto, as information necessary for UAM operation, UAM operation identification information, UAM flight corridor information to be flown, UAM aerodrome information, and UAM operation event information (UAM aerodrome departure time, arrival time, etc.

A UAM operator represents an organization that manages overall UAM operations and performs each UAM operation. The UAM operator corresponds to a server that includes a network unit for managing a flight plan (or intent) of each UAM or a PIC UAM aerial vehicle and transmitting and receiving real-time information to and from each UAM or the PIC UAM aerial vehicle, a storage unit for storing information necessary for flight of each UAM/PIC UAM, a processor for monitoring the flight of each UAM/PIC UAM aerial vehicle and controlling autonomous flight, and a display unit for displaying a flight status of each UAM/PIC UAM aerial vehicle in real time.

An unmanned aircraft system traffic management (UTM) operator is an operator who utilizes UTM-specific services to perform low-altitude unmanned aircraft system (UAS) operation, and corresponds to a server that includes a network unit for transmitting and receiving information to and from each aerial vehicle in real time, a storage unit for storing information necessary for each flight, a processor for monitoring the flight of each aerial vehicle and controlling autonomous flight, and a display unit for displaying a flight status of each aerial vehicle in real time.

In general, since aircraft tends to comply with the regulations of ICAO and the Federal Aviation Administration (FAA), which are international organizations, this specification will also describe the UAM concept from the viewpoint of the FAA establishing regulations for safe operation of UAM.

First, in order to prevent accidents such as a midair collision between the UAM aerial vehicle or between the UAM aerial vehicle and the non-UAM aerial vehicle, it should be possible for the UAM operators to access FAA National Airspace System (NAS) data through FAA-industry data exchange protocols.

This approach enables authenticated data flow between the UAM operators and FAA operating systems. Referring to FIG. 1, UAM operators 154a, 154b, and 154c according to the present disclosure may be configured by a distributed network utilizing an interoperable information system.

In addition, the UAM operators 154a, 154b, and 154c may perform the UAM operation in a scheduled service or on-demand service method through a request of an individual customer or an intermodal operator.

The UAM operators 154a, 154b, and 154c are responsible for all aspects of regulatory compliance and UAM operational execution.

Hereinafter, the use of the term “operator” in this specification refers to an airspace user who has chosen to be operated through cooperative management within the UAM environment. More specifically, the operator may include a UAM operating system including electronic devices that include a processor, memory, database, network interface, communication module, etc., that are connected to a wired/wireless network to perform various controls and management required for the UAM operation.

The UAM operators 154a, 154b, and 154c may be closely connected to PIC/UAM aerial vehicles 152a, 152b, and 152c to exchange various information (flight corridor information, airframe condition information, weather information, aerodrome information, arrival time, departure time, map data, etc.) for flight of the plurality of PIC/UAM aerial vehicles 152a, 152b, and 152c in real time.

A volume of a group of the PIC/UAM aerial vehicles 152a, 152b, and 152c that each of the UAM operators 154a, 154b, and 154c may manage may be set differently according to the capability of the UAM operators 154a, 154b, and 154c. In this case, the capability information of the UAM operators 154a, 154b, and 154c may include the number of UAM aerial vehicles that may be accessed simultaneously, the number of UAM aerial vehicles that may be controlled simultaneously, a network traffic processing speed, processor capability of a server system, and a range of a control area, etc.

Among the plurality of PIC/UAM aerial vehicles 152a, 152b, and 152c, the PIC/UAM aerial vehicle controlled by the same UAM operators 154a, 154b, and 154c may each be grouped into one group and managed. In addition, inter-airframe vehicle to vehicle (V2V) communication 153a may be performed between the PIC/UAM aerial vehicles 152a, 152b, and 152c within the grouped group, and information related to operation may be shared through V2V communication between the PIC/UAM aerial vehicles 152a, 152b, and 152c included in different groups.

To determine desired UAM operational flight plan information such as location of flight (e.g., aerodrome locations), route (e.g., specific UAM corridor(s)), and desired flight time, the UAM operators 154a, 154b, and 154c acquire current status/conditions from at least one of information (environment, situational awareness information, strategic operational demand information, and UAM aerodrome availability) that a PSU 102 and a supplemental data service provider (SDSP) 130 provide.

The UAM operators 154a, 154b, and 154c should provide the flight plan and navigation data to the PSU 102 to be operated within or cross the UAM flight corridor.

In addition, the UAM operators 154a, 154b, and 154c should set planning data in advance for proper preparation when an off-nominal event occurs. The planning data includes understanding of alternative landing sites and the airspace classes bordering the UAM flight corridor(s) for operations.

When all preparations for the UAM operation are completed, the UAM operators 154a, 154b, and 154c provide the information related to the corresponding UAM operation to the PSU 102. In this case, the UAM operators 154a, 154b, and 154c may suspend or cancel the flight of the UAM aerial vehicle until a flight permission message is received from the PSU 102. In another embodiment, even if the UAM operators 154a, 154b, and 154c do not receive the flight permission message from the PSU 102, the UAM operators 154a, 154b, and 154c may start the flight of the UAM aerial vehicle by themselves.

In FIG. 1, the pilot in command (PIC) represents a case where a person responsible for operation and safety of the UAM in flight is on board the UAM aerial vehicle.

The provider of services for a UAM (PSU) 102 may serve as an agency that assists the UAM operators 154a, 154b, and 154c to meet UAM operational requirements for safe and efficient use of airspace.

In addition, the PSU 102 may be closely connected with stakeholders 108 and the public 106 for public safety.

To support the capability of the UAM operators 154a, 154b, and 154c to meet the regulations and operating procedures for the UAM operation, the PSU 102 provides a communication bridge between UAMs and a communication bridge between PSUs and other PSUs through the PSU network 206.

The PSU 102 collects the information on the UAM operation planned for the UAM flight corridor through the PSU network 206, and provides the collected information to the UAM operators 154a, 154b, and 154c to confirm the duty performance capability of the UAM operators 154a, 154b, and 154c. Also, the PSU 102 receives/exchanges the information on the UAM aerial vehicles 152a, 152b, and 152c through the UAM operators 154a, 154b, and 154c during the UAM operation.

The PSU 102 provides the confirmed flight plan to other PSUs through the PSU network 206.

In addition, the PSU 102 distributes notification of an operating area in the flight plan (constraints, restrictions), FAA operational data and advisories, and weather and additional data to the UAM operators 154a, 154b, and 154c.

The PSU 102 may acquire UTM flight information through a UAS service supplier (USS) 104 network, and the USS network may acquire the UAM flight information through the PSU network 206.

In addition, the UAM operators 154a, 154b, and 154c may confirm the flight plan shared through the PSUs 102 and other UAM operators, and flight plan information for other flights in the vicinity, thereby controlling safer UAM flights.

The PSU 102 may be connected to other PSUs through the PSU networks 206 to acquire subscriber information, FAA data, SDSP data, and USS data.

The UAM operators 154a, 154b, and 154c and the PSU 102 may use the supplemental data service provider (SDSP) 130 to access support data including terrain, obstacles, aerodrome availability, weather information, and map data for a three-dimensional space. The UAM operators 154a, 154b, and 154c may access the SDSP 130 directly or through PSU network 206.

The USS 104 serves to support the UAS operation under the UAS traffic control (UTM) system.

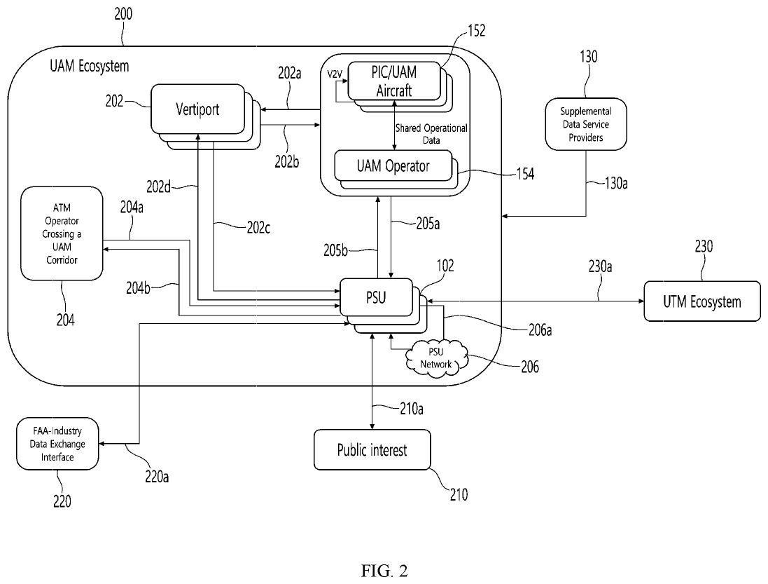

FIG. 2 is a diagram for describing an ecosystem of the UAM according to the embodiment of the present disclosure.

Referring to FIG. 2, the PIC/UAM aerial vehicle 152 and the UAM operator 154 transmit UAM operational intent information and UAM real-time data to a vertiport management system 202 (202a), and the vertiport management system 202 transmits vertiport capacity information and vertiport status information to the PIC/UAM aerial vehicle 152 and the UAM operator 154 (202b).

In addition, the PIC/UAM aerial vehicle 152 and the UAM operator 154 transmit a UAM operational intent request message, UAM real-time data, and UAM operation departure phase status information to the PSU 102 (205a).

The PSU 102 transmits UAM notifications, UAM corridor information, vertiport status information, vertiport acceptance information, and UAM operation intent response message to the PIC/UAM aerial vehicle 152 and the UAM operator 154 (205b). In this case, the UAM operational intent response message includes a response message informing of approval/deny, etc., for the UAM operational intent request.

The vertiport management system 202 transmits the UAM operation departure phase status information, the vertiport status information, and the vertiport acceptance information to the PSU 102 (202c). The PSU 102 transmits the UAM operational intent information and UAM real-time data to the vertiport management system 202 (202d).

In FIG. 2, when aerial vehicles (that is, non-UAMs) other than the UAM aerial vehicles need to cross the UAM flight corridor, the ATM operator 204 crossing the UAM flight corridor transmits a UAM flight corridor crossing request message to the PSU 102 (204a), and the PSU 102 transmits a response message to the UAM flight corridor crossing request message (204b).

In addition, in FIG. 2, the PSU 102 may perform a procedure for synchronizing UAM data with PSUs connected through the PSU network 206.

In particular, the PSU 102 may exchange information with other PSUs through the PSU network 206 to enable UAM passengers and UAM operators to smoothly provide UAM services (e.g., exchange of flight plan information, notification of UAM flight corridor status, etc.).

In addition, the PSU 102 may prevent risks such as collisions with the UAM aerial vehicle and the unmanned aerial vehicle, and transmit and receive UAM off-nominal operational information and UTM off-nominal operational information to and from the UTM ecosystem 230 for smooth control in real time (230a).

In addition, the PSU 102 shares FAA and UAM flight corridor availability, UAM flight corridor definition information, NAS data, a UAM information request, and response to the UAM information request, UAM flight corridor status information, and UAM off-nominal operational information through the FAA industrial data exchange interface 220 (220a).

In addition, the PSU 102 may transmit and receive the UAM information request and the response to the UAM information request to and from a public interest agency system 210. The public interest agency system 210 may be an organization defined by a management process (e.g., FAA, CBR) to have access to the UAM operation information. This access may support activities that include public right to know, government regulation, government guaranteed safety and security, and public safety. Examples of public interest stakeholders include regional law enforcement agencies and United States federal government agencies.

In addition, the UAM ecosystem 2 may receive supplemental data such as terrain information, weather information, and obstacles from supplemental data service providers (SDSP) 130 (130a), and thus, generate information necessary for safe operation of the UAM aerial vehicle.

In an embodiment of the present disclosure, the PSU 102 may confirm a corresponding UAM flight corridor use status through UAM flight corridor use status (e.g., active, inactive) information. For example, when the UAM flight corridor use status information is set to “active,” the PSU 102 may identify whether the UAM flight is scheduled or whether the UAM aerial vehicle is currently flying in the corresponding flight corridor, and when the UAM flight corridor use status information is set to “inactive”, the PSU 102 may identify that there is no UAM aerial vehicle currently flying in the corresponding flight corridor.

In addition, the PSU 102 may store operation data related to the flight of the UAM aerial vehicle in an internal database in order to identify a cause of an accident of the UAM aerial vehicle in the future.

These key functions allow the PSU 102 to provide the FAA with cooperative management of the UAM operation without being directly involved in UAM flight.

The PSU 102 may perform operations related to flight planning, flight plan sharing, strategic and tactical conflict resolution, an airspace management function, and an off-nominal operation.

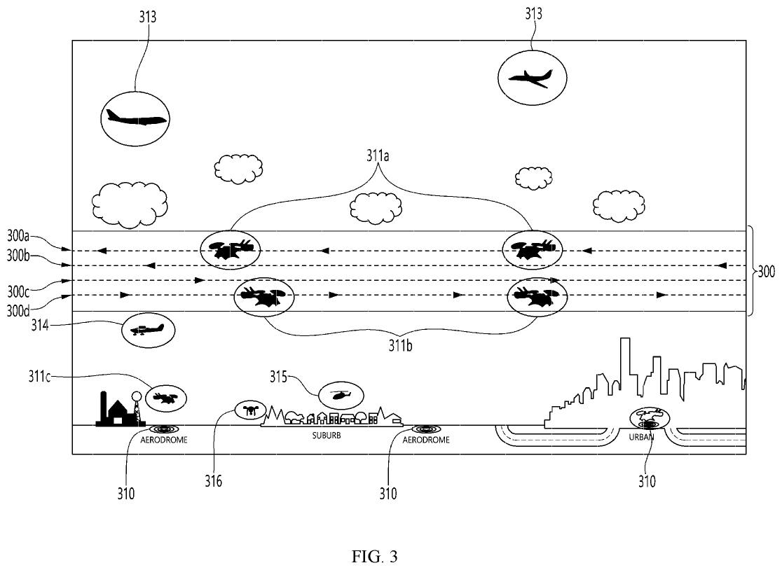

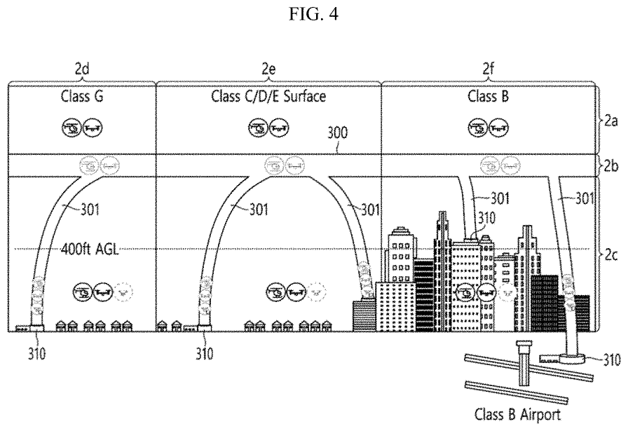

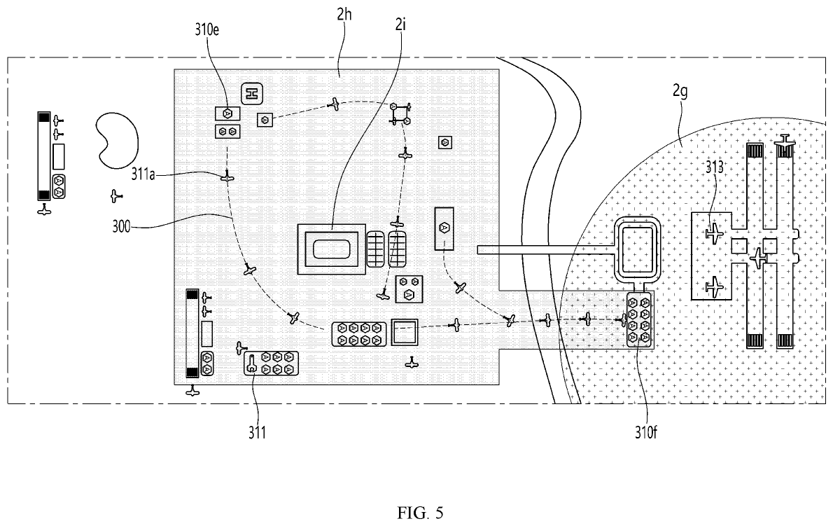

FIG. 3 is a diagram for describing locations of tracks and aerodromes on which UAMs fly within a UAM flight corridor according to an embodiment of the present disclosure, and FIGS. 4 and 5 are diagrams illustrating the UAM flight corridor according to the embodiment of the present disclosure.

It will be described with reference to FIGS. 3 to 5 below.

Referring to FIG. 3, for efficient and safe flight of UAM aerial vehicles 311a and 311b within a UAM flight corridor 300 according to an embodiment of the present disclosure, a plurality of tracks 300a, 300b, 300c, and 300d are provided within the corresponding flight corridor. Each of the tracks 300a, 300b, 300c, and 300d has different altitudes to prevent a collision between the UAM aerial vehicles 311a and 311b, and the number of tracks will be differently set depending on the capacity of the corresponding flight corridor 300.

A UAM aerodrome 310 is an aerodrome that meets capability requirements to support UAM departure and arrival operations. The UAM aerodrome 310 provides current and future resource availability information for UAM operations (e.g., open/closed, pad availability) to support UAM operator planning and PSU strategic conflict resolution. The UAM operator 154 may directly use the UAM aerodrome 310 through the PSU network 206 or through the SDSP 130.

In FIG. 3, the UAM flight corridor 300 should be set to enable the safe and efficient UAM operation without a tactical ATC separation service. Therefore, the UAM flight corridor 300 should be set in relation to the capabilities (e.g., aerial vehicle performance, UAM flight corridor structure, and UAM procedure) of the UAM operator 154.

Additionally, the PSU 102 or the UAM operator 154 may be operated differently within the UAM flight corridor 300 according to operation performance (e.g., aircraft performance envelope, navigation, detection-and-avoidance (DAA)) and participation conditions (e.g., flight intention sharing, conflict resolution within the UAM corridor) of the UAM flight corridor 300.

In addition, the PSU 102 or the UAM operator 154 may set performance and participation requirements of the UAM flight corridor 300 differently between the UAM corridors.

Specifically, the PSU 102 or the UAM operator 154 may variably set the range (flight altitude range) of the UAM flight corridor 300 in consideration of information such as the number of UAM aerial vehicles using the corresponding UAM flight corridor 300, an occupancy request of managements systems (e.g., UTM, ATM) for other aerial vehicles for the corresponding airspace, a prohibited area, and a flight limit altitude.

In addition, the PSU 102 or the UAM operator 154 may share, as the status information for the set UAM flight corridor 300, the UAM flight information (flight time, flight altitude, track ID within the flight corridor, etc.) within the UAM flight corridor with other UAM operators and/or PSUs through the PSU network 206.

Also, the PSU 102 or the UAM operator 154 may set the number of tracks 300a, 300b, 300c, and 300d in the flight corridor according to the range of the UAM flight corridor 300. It is preferable that the corresponding tracks 300a, 300b, 300c, and 300d are defined to have a safe guard set so that the PIC/UAM aerial vehicle 152 flying along the corresponding tracks does not collide with each other. Here, the safe guard may be set according to the height of the UAM aerial vehicle, or even when the UAM aerial vehicle temporarily deviates from a track assigned thereto due to a bird strike or other reasons, the safe guard may be a space set so as not to collide with other UAM aerial vehicles flying on the nearest neighbor track above and below the corresponding track.

In addition, the PSU 102 or the UAM operator 154 may set the tracks 300a, 300b, 300c, and 300d within the flight corridor according to the range of the UAM flight corridor 300, assign a track identifier (Track ID), which is an identifier in the flight corridor 300 for distinguishing the set tracks, and notify the PIC/UAM aerial vehicle 152 scheduled to fly within the corresponding UAM flight corridor 300 of the assigned track ID.

As a result, the PSU 102 or the UAM operator 154 may monitor in real time whether the PIC/UAM aerial vehicle 152 flying in the corresponding flight corridor 300 are flying along each assigned track ID, and when the PIC/UAM aerial vehicle 152 deviate from the assigned track ID, the PSU 102 or the UAM operator 154 may transmit a warning message to the corresponding PIC/UAM aerial vehicle 152, or remotely control the corresponding PIC/UAM aerial vehicle 152.

In the operating environment of the National Airspace System (NAS), the operation type, regulations and procedures of the airspace may be defined to enable the operation of the aerial vehicle, so the airspace according to the operating environment of the UAM, UTM, and air traffic management (ATM) may be defined as follows.

A UAM aerial vehicle 311 may be operated in the flight corridor 300 set above the area in which the UAM aerodromes 310 are located. In this case, the UAM aerial vehicle 311 may be operated in the above-described operable area based on the performance predefined in designing the airframe.

The unmanned aerial system traffic management (UTM) supports the safe operation of the unmanned aerial system (UAS) in an uncontrolled airspace (class G) below 400 ft (120 m) above ground level (AGL) and controlled airspaces (class B, C, D and, E).

On the other hand, the air traffic management (ATM) may be applied in the whole airspace.

In order to operate the UAM aerial vehicle 311, a fixed-wing aircraft 313, and helicopters 315 inside and outside the UAM flight corridor 300 according to the embodiment of the present disclosure, all aircrafts within the UAM flight corridor 300 operate under the regulations, procedures and performance requirements of the UAM. The case of the fixed-wing aircraft 313 and the aircraft controlled by the UTM may cross the UAM flight corridor 300.

In addition, it is preferable that the helicopter 315 and the UAM aerial vehicle 311 are operated in the UAM flight corridor 300, and outside the UAM flight corridor 300, in the outside of the UAM flight corridor 300, the helicopter 315 and the UAM aerial vehicle 311 comply with the operation form, the airspace class, and the flight altitude according to the regulations for the air traffic management (ATM) and the regulations for the UTM.

Of course, the same regulations as described above are applied to visual flight rules (VFR) 314 or unmanned drones 316 in which a pilot recognizes surrounding obstacles with his eyes and flies in a state in which a surrounding visual distance is wide.

The operation of each aerial vehicle described above does not depend on the airspace class, and may be applied based on the inside and outside of the flight corridor 300 of the UAM. Meanwhile, the airspace class may be classified according to purpose such as a controlled airspace, an uncontrolled airspace, a governed airspace, and an attention airspace, or classified according to provision of air traffic service.

The UAM flight corridor 300 allows the UAM aerial vehicle to be operated more safely and effectively without the technical separation control service (management of interference with other aerial vehicles for safety) according to the ATM. In addition, it is possible to help accelerate the operating tempo related to the operating capability, structure, and procedures of the UAM aerial vehicle. In addition, in the present disclosure, by defining the UAM flight corridor 300, it is possible to provide a clearer solution to agencies having an interest in the related field.

The UAM flight corridor 300 may be designed to minimize the impact on the existing ATM and UTM operations, and should be designed to not only consider the regional environment, noise, safety, and security, but also satisfy the needs of customers.

In addition, the effectiveness of the UAM flight corridor 300 should be consistent with the operation design (e.g., changing the flight direction during take-off and landing at a nearby airport or setting direct priority between opposing aircraft) of the ATM. Of course, the UAM flight corridor 300 may be designed to connect the locations of the UAM aerodromes 310 located at two different points for point-to-point connection.

The UAM aerial vehicle 311 may fly along a take-off and landing passage 301 connecting the flight corridor 300 in the aerodrome 310 to enter the UAM flight corridor 300, and the take-off and landing passage 301 may also be designed in a way that minimizes the impact on ATM and UTM operations and should be designed in a way that satisfies the requirements of customers as well as considering the regional environment, noise, safety, security, etc.

The airspace or operation separation within the UAM flight corridor 300 may be clarified through a variety of strategies and technologies. As a preferred embodiment for the airspace or operation separation within the UAM flight corridor 300, a collision may be strategically prevented based on a common flight area, and an area may be technically assigned to the UAM operator 154. In this case, in an embodiment of the present disclosure, PIC and aircraft performance or the like may be considered when separating the airspace or operation within the UAM flight corridor 300.

In addition, since the UAM operator 154 is responsible for safely conducting the UAM operation in association with aircraft, weather, terrain and hazards, it is also possible to separate the UAM flight corridor 300 through the shared flight intention/flight plan, awareness, strategic anti-collision, and establishment of procedural rules.

For example, it can be seen that the UAM flight corridor 300 in FIG. 3 is separated into two airspaces based on the flight direction of the UAM aerial vehicle 311a and 311b. In this case, in FIG. 3, in a relatively high airspace within the UAM flight corridor 300, the UAM aerial vehicle 311a may fly in one direction (from right to left), and in a relatively low airspace, the UAM aerial vehicle 311b may fly in a direction (from left to right) opposite to the one direction.

Meanwhile, the UAS service provider (USS) 104 and the SDSP 130 may provide the UAM operator 154 with weather, terrain, and obstacle information data for the UAM operation.

The UAM operator 154 may acquire the data at the flight planning stage to ensure updated strategic management during the UAM operation and flight, and the UAM operator 154 may continuously monitor the weather during the flight based on the data to make a plan or take technical measures to prevent emergencies such as collisions from occurring within the flight corridor.

Accordingly, the UAM operator 154 is responsible for identifying operation conditions or flight hazards that may affect the operation of the UAM, and this information should be collected during flight as well as pre-flight to ensure safe flight.

The PSU 102 may provide other air traffic information scheduled for cross operation within the UAM flight corridor 300, meteorological information such as meteorological wind speed and direction, information on hazards during low altitude flight, information on special airspace status (airspace prohibited areas, etc.), the availability for the UAM flight corridor 300, etc.

In addition, during the UAM operation, the identification information and location information of the UAM aerial vehicle 311 may be acquired through a connected network between the UAM operator 154 and the PSU 102, but is not preferably provided by automatic dependent surveillance-broadcast (ADS-B) or transponder.

Since the operation of UAM ultimately aims at the unmanned autonomous flight, the identification information and location information of the UAM aerial vehicle 311 are acquired or stored by the UAM operator 154 and the PSU 102, and are preferably used for the operation of the UAM.

Meanwhile, referring to FIG. 4, due to the characteristics of UAM that is operated to suit urban and suburban environments, the aerodrome 310 may be installed in several densely populated regions, and each aerodrome 310 may set a take-off and landing passage 301 connected to the UAM flight corridor 300.

The airspace according to the embodiment of the present disclosure may be divided into an airspace 2a of an area in which the fixed-wing aircraft 313 and rotary-wing aircraft 315, etc., are allowed to fly only according to the instrument flight Rules (IFR) vertically depending on altitude, an airspace 2b in which the UAM flight corridor 300 is formed and airspace 2c in which the take-off and landing passage 301 of the UAM aerial vehicle is formed.

The aerial vehicle illustrated in FIG. 4 may be divided into a UAM aerial vehicle (dotted line) flying in the UAM flight corridor 300, an aerial vehicle (solid line) flying in the airspace according to the operating environment of the air traffic management (ATM), and an aerial vehicle (unmanned aircraft system) (UAS) (dashed line) flying at low altitude operated by the unmanned aircraft system traffic management (UTM) operator.

The airspace according to the embodiment of the present disclosure may be horizontally divided into a plurality of airspaces 2d, 2e, and 2f according to the above-described airspace class.

Also, referring to FIG. 5, the airspace may be divided into an airspace 2g divided into an existing air traffic control (ATC) area and an area 2h where UAM operation or control is performed according to the operation or control area. Of course, the ATC control area 2g and the UAM operation or control area 2h may overlap depending on circumstances.

In the area 2h where the UAM operation or control is performed, a plurality of aerodromes 310e and 310f may exist for the point-to-point flight of the UAM aerial vehicle 311, and a prohibited area 2i may be set in the area 2h where the UAM operation or control is performed.

The UAM flight corridor 300 for the point-to-point flight may be set within the area 2h where the UAM operation or control is performed, except for the area set as the prohibited area 2i.

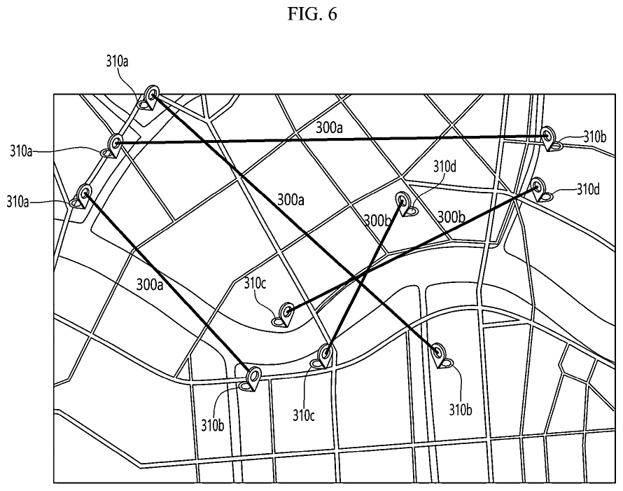

FIG. 6 is a diagram illustrating the aviation corridor of UAM for the point to point connection according to an embodiment of the present disclosure.

This will be described with reference to FIG. 6 below.

The flight corridors 300a and 300b of the UAM aerial vehicle may connect an aerodrome 310a in one region and an aerodrome 310b in another region. The connection between these points may be established within an area excluding special airspace such as the prohibited area 2i within the area 2h where the above-described UAM operation or control is performed, and the altitude at which the UAM flight corridor 300 is set may be set within the airspace 2b in which the UAM flight corridor 300 is set. Here, the aerodrome 310 may refer to, for example, a vertiport in which an aerial vehicle capable of vertical take-off and landing may take-off and land.

Hereinafter, the operation of the above-described UAM will be described.

The UAM may be operated in consideration with the operation within the UAM flight corridor 300, the strategic airspace separation, the real-time information exchange between the UAM operator 154 and the UAM aerial vehicle 311, the performance conditions of the UAM airframe, etc.

The flight of the UAM may be generally divided into a stage of planning a flight in a pre-flight stage, a take-off stage in which the UAM takes off from the aerodrome 310 and enters a vertical take-off and landing passage 51 and climbs, a climb stage in which the UAM climbs from the aerodrome 310 and enters the flight corridor 300, a cruise stage in which the UAM moves along the flight corridor 300, a descend and landing stage in which the UAM enters the take-off and landing passage 51 from the flight corridor 300, and then, descends and enters the aerodrome 310, a disembarking stage after flight, and operation inspection stage.

The operation in each stage may be performed by being divided into the UAM operator 154, the PSU 102 (or SDSP 130), the FAA, the aerodrome operator, and the PIC/UAM passenger. The PIC/UAM passenger may be understood as a concept including both a person who boards the airframe and controls the airframe and passengers who move through the airframe.

In the pre-flight planning stage, the UAM operator 154 may submit the flight plan to the FAA and confirm the passenger list and destination.

The PSU 102 may remove factors that may hinder flight or plan a strategy for the case where an off-nominal situation occurs.

The FAA may review the flight plan submitted by the UAM operator 154 to determine whether to approve the operational plan, and transmit the determination back to the UAM operator 154.

The aerodrome operator may inspect passengers and cargo, perform boarding of passengers, confirm whether the area around the aerodrome 310 is cleared for departure, and notify the UAM operator 154 and/or the PSU 102 of the information on the confirmed result.

The PIC/UAM passenger may finally confirm all hardware and software systems of the UAM aerial vehicle 311 for departure, and notify the UAM operator 154 and/or the PSU 102 through a communication device.

After the FAA notifies the approval of the UAM operation plan, it maintains the authority for the airspace in which the flight route is established in the PIC/UAM flight, but the UAM operators 154 who actually operate the UAM aerial vehicle and/or the PSU 102 directly control/govern the UAM flight operation, so it is preferable that the FAA does not actively participate in the UAM flight.

In addition, in the take-off stage in which the UAM aerial vehicle takes off the aerodrome 310 and climbs, the UAM operator 154 may approve a taxi request or a take-off request of a runway of an airport of the UAM aerial vehicle and transmit a response message thereto to each UAM.

The PSU 102 may sequentially assign priority to each of the plurality of UAM aerial vehicles to prevent the collision between the UAM aerial vehicles and to smoothly control the aerodrome. The PSU 102 controls and monitors only the UAM aerial vehicle to which priority is assigned to move to the runway or take-off.

Before taking off of the UAM aerial vehicle, the aerodrome operator may confirm the existence of obstacles that hinder the takeoff of the UAM around the aerodrome, and may approve the takeoff of the UAM aerial vehicle if there are no obstacles. The PIC/UAM passenger who has received the take-off approval may proceed with the take-off procedure of the UAM aerial vehicle.

In the climb stage in which the UAM aerial vehicle enters the take-off and landing passage 301 from the aerodrome 310, and then climbs and enters the flight corridor 300 and the cruise stage in which the UAM aerial vehicle moves along the flight corridor 300, the UAM operator 154 monitors whether the PIC/UAM is flying according to the flight plan or whether the overall flight operation plan is being followed. In addition, the UAM operator 154 may monitor the status of the UAM aerial vehicle 311 while exchanging data with the PSU 102 and the UAM aerial vehicle 311 in real time and update information and the like if necessary.

The PSU 102 may also monitor the status of the UAM aerial vehicle 311 while exchanging data with the UAM operator 154 and the UAM aerial vehicle 311 in real time, and may deliver the updated operation plan to the UAM operator 154 and the UAM aerial vehicle 311, if necessary.

When the UAM aerial vehicle 311 enters the cruise stage, the aerodrome operator no longer actively participates in the flight of the UAM aerial vehicle 311. In addition, the PIC/UAM aerial vehicle 311 may execute the take-off and cruise procedures, perform collision avoidance or the like through the V2V data exchange, monitor the system of the aerial vehicle in real time, and provide the UAM operator 154 and the PSU 102 with the information such as the aircraft status.

In the descending and landing stage, since the UAM aerial vehicles 152 and 311 have reached near a destination, the cruise mode is terminated and descends and enters the aerodrome 310 after entering the take-off and landing passage 301 from the flight corridor 300. Even during the descend and landing stage, the UAM operator 154 may continuously monitor the flight status/airframe status of the UAM aerial vehicles 152 and 311 and at the same time, monitor whether the flight of the UAM aerial vehicles 152 and 311 complies with a predefined flight operation plan.

In addition, the UAM aerial vehicles 152 and 311 may be assigned a gate number or gate identification information to land on the aerodrome through communication with the aerodrome operator while entering the take-off and landing passage 301, and confirm whether the current airframe status is ready for landing (landing gear operation, flaps, rotor status, output status, etc.).

The PSU 102 may request the approval of the landing permission of the UAM aerial vehicle 311 from the aerodrome operator, and transmit, to the UAM aerial vehicle 311, information including compliance matters for moving from the current flight corridor or location of the UAM aerial vehicle 311 to the UAM aerodrome 310 permitted to land.

In addition, the UAM aerial vehicle 311 may confirm whether the aerodrome 310 is in a clear status (status in which all elements that may be obstacles to the landing of the UAM aerial vehicle 311 are removed) through communication with the UAM aerodrome 310, the PSU 102, and the UAM operator 154, and after the landing of the UAM aerial vehicle 311 is completed, the UAM aerial vehicle 311, the PSU 102, and the UAM operator 154 may all identify the end of the flight operation of the corresponding UAM aerial vehicle.

When receiving the landing request from the UAM aerial vehicle 311, the aerodrome operator confirms a gate cleared out of the aerodrome. In addition, when the aerodrome operator secures whether the landing is possible for the confirmed gate, the aerodrome operator transmits landing permission message including the gate ID or gate number to the UAM aerial vehicle 311, and assigns a gate corresponding to a landing zone included in the landing permission message to the UAM aerial vehicle 311.

Also, when receiving the landing permission message from the aerodrome operator, the UAM aerial vehicle 311 lands at a gate assigned thereto according to a predetermined landing procedure.

The PIC/UAM passengers may perform the take-off and landing procedure of the UAM aerial vehicle 311, and may perform procedures of preventing collisions with other UAM aerial vehicles while maintaining V2V communication and moving to a runway after landing.

The stage of planning the flight of the UAM aerial vehicle 311 starts with receiving the flight requirements of the UAM aerial vehicle 311 for the UAM operator 154 to fly point to point between the first aerodrome and the second aerodrome. In this case, the UAM operator 154 may receive data (e.g., weather, situation awareness, demand, UAM aerodrome availability, and other data) for the flight of the UAM aerial vehicle 311 from the PSU 102 or SDSP 130.

In all the stages related to the UAM operation, the UAM operator 154 and the PSU 102 not only need to confirm the identification and location information of the UAM aerial vehicle in real time, but also the PIC/UAM and UAM operator 154 needs to monitor the performance/condition of the aerial vehicle in real time to identify whether the flight status of the UAM aerial vehicle 311 is off-nominal.

Meanwhile, the UAM aerial vehicle 311 may have an off-nominal status for various reasons such as weather conditions and airframe failure. The off-nominal status may refer to an operating situation in which the UAM aerial vehicle 311 does not follow a flight plan planned before flight due to various external or internal factors.

Two cases may be assumed as the case in which the off-nominal flight condition occurs in the UAM aerial vehicle 311. The first case is a case where the PIC/UAM aerial vehicle 152 intentionally does not comply with UAM regulations due to any other reason, and the second case is the unintentional non-compliance with the UAM operating procedures due to contingencies.

In the first case, it may be assumed that the case where the UAM aerial vehicle 311 intentionally (or systematically) does not comply with the planned UAM operating regulations is the case where the UAM aerial vehicle 311 does not comply with the planned flight operation due to airframe performance problems, strong winds, navigation failure, etc.

However, in the first case, the PIC/UAM aerial vehicle 152 may be in a state in which it may safely arrive at the planned aerodrome 310 within the flight corridor 300.

When the PSU 102 identifies that the off-nominal operation according to the first case has occurred in the PIC/UAM aerial vehicle 152, the PSU 102 distributes, to each stakeholder (UAM operator 154, USS 104, vertiport operator 202, UTM ecosystem 230, ATM operators 204, etc.) through a wired/wireless network, PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the UAM operator 154 and the PSU 102 receiving the PIC/UAM aerial vehicle off-nominal event occurrence information may generate a new UAM operation plan that may satisfy UAM community based rules (CBR) and performance requirements for operation within the flight corridor 300, and distribute the generated new UAM operation plan to stakeholders again.

In the second case, the case where the UAM aerial vehicle 152 unintentionally does not comply with the UAM operation due to an accidental situation may be a state in which the forced landing (crash landing) of the UAM aerial vehicle 152 is required, and may be a severe situation where the planned flight operation may not be performed.

That is, the second case is the case where, since it is difficult for the PIC/UAM aerial vehicle 152 to safely fly to the planned aerodrome 310 within the flight corridor 300 assigned thereto, the PIC/UAM aerial vehicle 152 may not fly within the flight corridor 300 assigned thereto.

When the off-nominal operation according to the second case has occurred, similar to the first case, the PSU 102 distributes, to each stakeholder (UAM operator 154, USS 104, vertiport operator 202, UTM ecosystem 230, ATM operators 204, etc.) through the wired/wireless network, the PIC/UAM aerial vehicle off-nominal event occurrence information (UAM aerial vehicle identifier where an off-nominal event occurred, UAM aerial vehicle locations (flight corridor identifier, track identifier), information (event type) notifying a type of off-nominal situations, etc.) notifying that an off-nominal operation status has occurred in the PIC/UAM aerial vehicle 152.

In addition, the PIC/UAM aerial vehicle 152 is reassigned a new flight corridor 300 for flight to a previously secured landing spot and a track identifier within the flight corridor 300 in preparation for an emergency situation in the UAM aerial vehicle, and at the same time, may fly in a flight mode to avoid collision damage with other aerial vehicles through communication means (ADS-B, etc.).

Hereinafter, an evaluation indicator for the operation of the UAM aerial vehicle according to an embodiment of the present disclosure will be described.

As shown in <Table 1> below, UAM operational evaluation indicators may include major indicators such as operation tempo, UAM structure (airspace and procedures), UAM regulatory changes, UAM community regulations (CBR), aircraft automation level, etc.

TABLE 1

| Indicator Item | Description |
|---|---|
| Operation Tempo | It indicates density of UAM |
| | operation, frequency of UAM |
| | operation, and complexity of UAM |
| | operation. |
| UAM Operation | It indicates complex level of |
| Structure | infrastructure and services |
| (Airspace and | supporting UAM operating |
| Procedure) | environment . |
| UAM Operation | It indicates level of evolution of |
| Regulation | current regulations required for |
| | UAM operation structure and |
| | performance. |
| UAM Community Laws and | It indicates rules supplementing |
| Regulations | UAM operation regulations for UAM |
| | operation and expansion of PSU. |
| Aircraft Automation | It may be divided into HWTL (Human- |
| | Within-The-Loop) , HOTL (Human-On- |
| | The-Loop) , HOVTL (Human-Over-The- |
| | Loop) . |
| Level | 1) HWTL: Stage where person |
| | directly controls UAM system |
| | 2) HOTL: Stage of system that is |
| | controlled under human |
| | supervision, i.e., stage in which |
| | human actively monitors |
| | 3) HOVTL: Stage in which human |
| | performs monitoring passively |

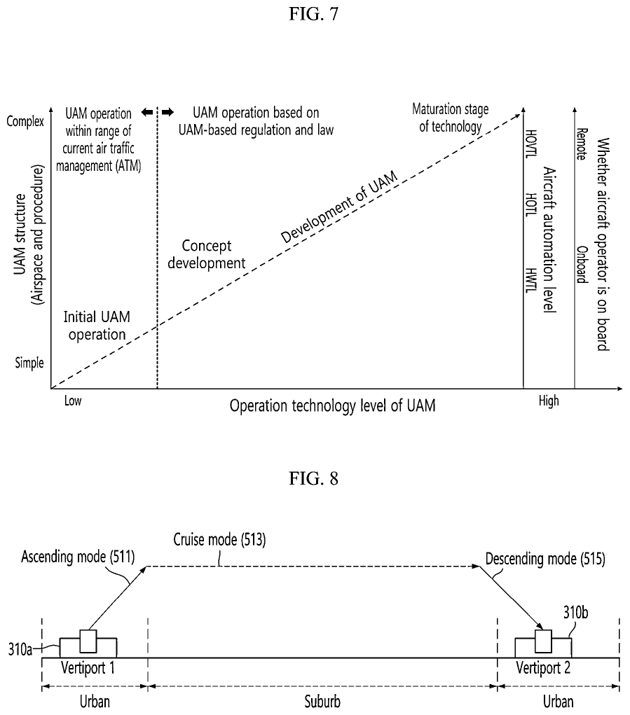

FIG. 7 is a diagram illustrating a development stage of an operating technology level of the UAM.

Hereinafter, concepts of an initial UAM operation stage, a transitional UAM operation stage, and a final UAM operation stage will be described with reference to the above-described key indicators and FIG. 7.

First, in the initial UAM operation stage, the structure of the UAM aerial vehicle is likely to use various existing vertical take-off and landing (VTOL) rotary-wing aircraft infrastructures.

The UAM's regulatory changes may be gradually implemented while complying with aviation regulations and the like under current laws and regulations. However, the UAM community rules (CBR) may not be separately defined.

The aircraft automation level borrows manned rotary-wing technology, which is currently widely used as of the time this specification is written, but an on-board status may be applied to the pilot in command (PIC) stage.

Next, looking at the transitional UAM operation step, in the UAM structure, the UAM airframe may be operated within a specific airspace based on the performance and requirements of the UAM aerial vehicle.

As for UAM regulations, the ATM regulations may be changed and applied, new regulations for a UAM that can be operated may be defined, and the UAM community regulations may also be defined.

In the transitional UAM operation stage, the automation level of the UAM aerial vehicle may be capable of PIC control with an airframe designed exclusively for the UAM, but the on-board status may still be maintained as the PIC stage.

Finally, looking at the final UAM operation stage, the UAM airframe may be operated in a specific airspace based on the performance and requirements of the UAM aerial vehicle, but several variables may exist.

It is predicted that the UAM regulation changes will require additional regulations to enable various operations within the UAM flight corridor, and as the complexity of the UAM community regulations increases, FAA guidelines are expected to increase.

Due to the development of artificial intelligence (AI) technology and the development of aviation airframe technology, the aircraft automation level will be realized at a higher automation level compared to the UAM aerial vehicle at the existing stage. As a result, it is predicted that it will reach the unmanned horizontal or vertical take-off or landing technology level, and the PIC stage may be a stage where remote control is possible.

FIG. 8 is a diagram for describing a flight mode of the UAM aerial vehicle according to an exemplary embodiment of the present disclosure.

Referring to FIG. 8, in an embodiment of the present disclosure, the flight mode of the UAM aerial vehicle may include a take-off mode (not illustrated), an ascending mode 511, a cruise mode 513, a descending mode 515, and a landing mode (not illustrated).

The take-off mode is a mode in which the UAM aerial vehicle takes off from a vertiport 310a at the starting point, the ascending mode 511 is a mode in which the UAM aerial vehicle performs a stage of ascending the flight altitude step by step to enter the cruise altitude, the cruise mode 513 is a mode in which the UAM aerial vehicle flies along the cruise altitude, the descending mode 515 is a mode in which the UAM aerial vehicle performs a stage of descending the altitude step by step in order to land from the cruise altitude to the vertiport 310b of the destination, and the landing stage is a mode in which the UAM aerial vehicle lands on the vertiport 310b of the destination.

In addition, in the take-off mode, the UAM aerial vehicle may perform a taxiing stage to enter the vertiport 310a of the departure point, and even after the landing stage, the UAM aerial vehicle may perform the taxiing stage to enter the vertiport 310b of the destination.

In another embodiment of the present embodiment, in the case of the vertical take-off and landing (VTOL), a take-off mode and the ascending mode 511 may be performed simultaneously, and a landing mode and descending mode 515 may also be performed simultaneously.

In this embodiment, the UAM aerial vehicle is a type of urban transport air transportation means, and the vertiport 310a of the departure point and the vertiport 310b of the destination may be located in the urban area, and according to the cruise mode 513, the aviation corridor on which the UAM aerial vehicle flies may be located in the suburban area outside the urban area.

According to the above-described embodiment of the present disclosure, the take-off mode, the ascending mode 511, the descending mode 515, and the landing mode of the UAM aerial vehicle are performed in a densely populated urban area so thrust may be generated through a distributed electric propulsion (DEP) method to suppress the generation of soot and noise caused by an internal combustion engine.

On the other hand, in the cruise mode 513 of the UAM aerial vehicle, which is mainly performed in the suburban area, the thrust may be generated by an internal combustion engine (ICE) propulsion method in order to increase an operating range, a payload, a flying time, etc.

Of course, the propulsion method for generating the thrust of the UAM aerial vehicle is not necessarily determined for each flight mode described above, and the thrust of the UAM aerial vehicle may be selected by either the DEP method or the ICE method by additionally considering various factors such as the location, altitude, speed, status, and weight of the UAM aerial vehicle.

The operation of the propulsion system according to the flight area of the UAM aerial vehicle according to the embodiment of the present disclosure illustrated in FIG. 8 is summarized in <Table 2> below.

TABLE 2

| | Description of propulsion system operation - |
|---|---|
| Flight Area | control |
| Urban | Generate lift and thrust only with battery, |
| | not internal combustion engines, in |
| | consideration of low noise and eco-friendliness |
| | Flight by selecting propulsion unit that may |
| | generate thrust/lift as much as data trained in |
| | advance through machine learning (ML) rather |
| | than full propulsion system, and generating |
| | lift/thrust with only selected propulsion unit |
| Suburb | In suburban area, which is less sensitive to |
| | noise and eco-friendliness than in urban area, |
| | thrust is generated through all propulsion |
| | units to enable full power flight for cruise |
| | flight, and power is supplied through battery |
| | or internal combustion engine |

Meanwhile, in the flight stage including the above-described take-off mode (not illustrated), ascending mode 511, cruise mode 513, descending mode 515, and landing mode (not illustrated), the UAM aerial vehicle may display an augmented reality guidance screen for UAM aerial vehicle passengers including pilots, passengers, etc. Hereinafter, a method of providing augmented reality guidance according to an embodiment of the present disclosure will be described in more detail.

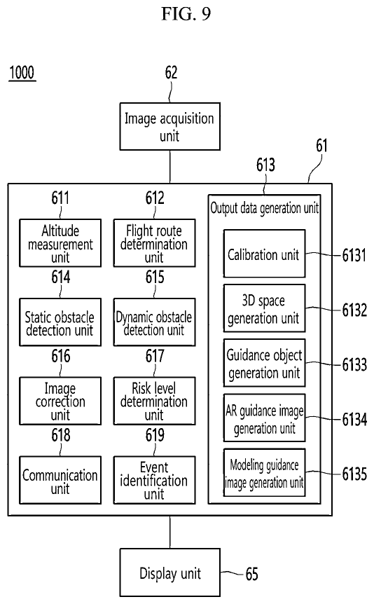

FIG. 9 is a block diagram illustrating a configuration of an apparatus for providing augmented reality guidance for an aerial vehicle according to an embodiment of the present disclosure. Referring to FIG. 9, an apparatus 1000 for providing augmented reality guidance may include all or part of an image acquisition unit 62, a data processing unit 61, and a display unit 65.

The image acquisition unit 62 may acquire a flight image of an aerial vehicle captured through a camera installed in the aerial vehicle. Here, the flight image of the aerial vehicle may be a concept that includes all images captured by a camera during the entire flight stage of the aerial vehicle, including the take-off stage, ascending stage, cruise stage, descending stage, and landing stage of the aerial vehicle.

The camera may be provided at a location where it does not interfere with the body of the aerial vehicle or a component providing lift in blades. A plurality of cameras may be provided. In addition, in the case of the camera installed under the aerial vehicle among the plurality of cameras, the camera can be used as an AR landing aid when the aerial vehicle lands.

The camera may be provided to be tiltable. More specifically, the camera may be rotatably provided to correspond to an attitude control (roll, pitch, yaw) of the aerial vehicle. As the camera rotates in response to the attitude control of the aerial vehicle, an angle of view of the image acquired through the camera may be guaranteed, so that an image in a certain direction may be obtained independently of the attitude control of the aerial vehicle.

The data processing unit 61 may process various data collected in the overall flight stage of the aerial vehicle, including the take-off stage, ascending stage, cruise stage, descending stage, and landing stage of the aerial vehicle, and perform the control functions of each module.

Here, the data processing unit 61 includes all or part of an altitude measurement unit 611, a flight route determination unit 612, an output data generation unit 613, a static obstacle detection unit 614, a dynamic obstacle detection unit 615, an image correction unit 616, a risk level determination unit 617, a communication unit 617, and an event identification unit 619.

The image correction unit 616 may perform image stabilization on the aerial vehicle flight image acquired by the image acquisition unit 62. For example, the image correction unit 616 may use an OIS method of performing image stabilization in hardware using a gyro sensor, an EIS method of performing image stabilization by cropping a central region of an image using a gyro sensor, etc., to perform the correction of the aerial vehicle flight image acquired by the image acquisition unit 62.

The communication unit 618 is a module for a communication function of the apparatus 1000 for providing augmented reality guidance, and the communication unit 618 may receive information transmitted from a control unit or a base station. Here, examples of the information transmitted from the control unit and the base station may include weather information of a flight zone, information of a prohibited area, flight information of other aerial vehicles, and the like. Among the information received through the communication unit 618, information directly or indirectly affecting the flight route of the aerial vehicle may be displayed through the display unit 65.

The altitude measurement unit 611 may measure the altitude of the aerial vehicle. Here, the altitude of the aerial vehicle measured by the altitude measurement unit 611 may be used to perform whether an aerial vehicle is flying through flight corridors, calculate the altitude of the aerial vehicle during landing, calculate a relative location of the aerial vehicle and the obstacle detected by the obstacle detection units 614 and 615, determine a designated altitude, route deviation, etc., by being used along with a flight route calculated by the flight route determination unit 612.

When the aerial vehicle departs from the designated altitude or leaves the safe altitude and approaches the limit of the designated altitude, an AR guidance object generation unit 6133, which will be described later, may generate an AR altitude danger guidance object.

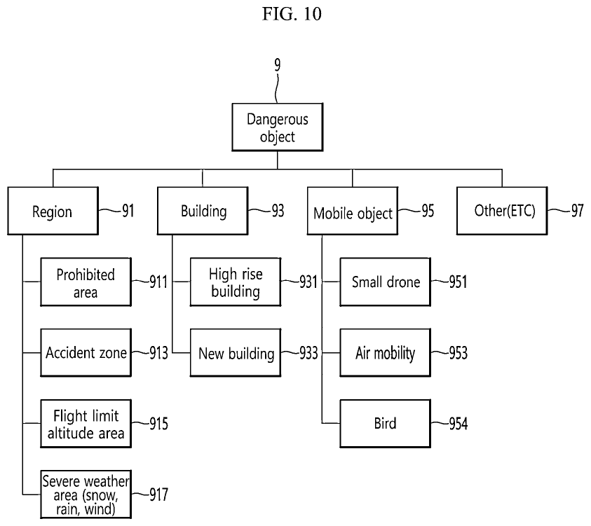

The obstacle detection units 614 and 615 may include a static obstacle detection unit 614 and a dynamic obstacle detection unit 615. Obstacles or hazards may be divided into static obstacles defined as regions, buildings, etc., dynamic obstacles defined as mobile objects, and others. This will be described below with reference to FIG. 10.

The map data may include dynamic map data that is updated in real time by reflecting pre-constructed static map data and dynamic obstacle information.

The static obstacle detection unit 614 may detect static obstacles using static obstacle information included in the pre-constructed static map data or may detect static obstacles by analyzing an image acquired by the image acquiring unit 62.

The dynamic obstacle detection unit 615 may detect a dynamic obstacle using dynamic obstacle information included in the dynamic map data, or may detect a dynamic obstacle by analyzing an image acquired by the image acquisition unit 62.

The risk level determination unit 617 may determine a risk of a flight route based on dynamic hazard information mapped to map data of an aerial vehicle. Here, the dynamic hazard information may include at least one of weather information, bird flock information, and other aerial vehicles information. For example, the risk level determination unit 617 may determine the risk of the flight route through a distance, a speed, or the like between the obstacle and the aerial vehicle.

In addition, the risk level determination unit 617 may determine the risk level by applying a weight to the hazard information. Here, the calculated risk level may be used as a standard parameter for displaying a guidance object differently.

The flight route determination unit 612 may generate a route for flight to the destination of the aerial vehicle based on the above-described map data, and the flight route determination unit 612 may determine whether the aerial vehicle has deviated from the generated flight route. The flight route may include all traveling of the aerial vehicle in the flight plan including take-off, ascending, flight, descending, landing, and taxiing of the aerial vehicle.

The event identification unit 619 may detect an event from an aerial vehicle flight image while the aerial vehicle is in flight, and may identify a type of events. An event guidance object indicating the event may be displayed on a guidance image through the display unit 65 according to the identified type of events. Here, the event may include at least one of a bird flock event, a collision risk building, a vertiport, and a prohibited area.

The output data generation unit 613 may generate display data to be displayed through the display unit 65 and/or voice data to be output through a speaker (not illustrated). In particular, the output data generation unit 613 may perform an image rendering process for image display. The output data generation unit 613 may include all or part of a calibration unit 6131, a 3D space generation unit 6132, a guidance object generation unit 6133, an AR guidance image generation unit 6134, and a modeling guidance image generation unit 6135. In particular, in order to display the augmented reality image, the output data generation unit 613 may use all or part of component modules.

The calibration unit 6131 may perform calibration for estimating camera parameters corresponding to the camera from the image captured by the camera. Here, the camera parameters, which are parameters configuring a camera matrix, which is information indicating a relationship between a real space and a photograph, may include camera extrinsic parameters and camera intrinsic parameters.

The 3D space generation unit 6132 may generate a virtual 3D space based on the image captured by the camera. In detail, the 3D space generation unit 6132 may generate the virtual 3D space by applying the camera parameters estimated by the calibration unit 6131 to a 2D captured image.

The guidance object generation unit 6133 may generate an object for various types of guidance, for example, a route guidance object, or the like during the flight of the aerial vehicle. For example, the guidance object generation unit 6133 may generate an augmented reality (AR) route guidance object based on a flight route for flight to a destination of an aerial vehicle generated by the flight route determination unit 612.

The AR guidance image generation unit 6134 may generate an AR guidance image by mapping the guidance object generated by the guidance object generation unit 6133 to an aerial vehicle flight image.

Here, the AR guidance image may include an AR guidance image of a head up display (HUD) method displaying an AR guidance object on a forward image that is transmitted through a windshield of an aerial vehicle and is shown to passengers.

For example, the AR guidance image generation unit 6134 may determine a projection location of the AR guidance object on the windshield by determining the mapping location of the object between virtual 3D spaces in the 3D space generation unit 6132. Accordingly, it is possible to generate the AR guidance image.

In addition, the AR guidance image may include an AR guidance image of a screen display method displaying an AR guidance object on a captured aerial vehicle flight image shown to a passenger through a screen.

For example, the AR guidance image generation unit 6134 may determine the mapping location of the object in the virtual 3D space in the 3D space generation unit 6132 and generate a 2D image corresponding to the virtual 3D space to which the object is mapped, thereby generating the AR guidance image.

The modeling guidance image generation unit 6135 may generate the modeling guidance image by combining the guidance object generated by the guidance object generation unit 6133 with the 2D or 3D modeling image.

Meanwhile, the display unit 65 may display the guidance image generated by the output data generation unit 613. For example, the display unit 65 may display an AR guidance image on one screen and a modeling guidance image on the other screen.

FIG. 10 is a diagram illustrating a hazard according to an embodiment of the present disclosure.

The hazard will be described with reference to FIG. 10 below.

The classification criteria of the hazard 9 of this embodiment can be divided into four major categories: a region 91, a building 93, a mobile object 95, and others 97.

The region 91 unit may be divided into a prohibited area 911, an accident zone 913, a flight restricted altitude zone 915, and a severe weather area 917 where normal flight is difficult, and buildings 93, and the building 93 may include an existing high-rise building 931 and a new building 933.

The mobile object 95 may be divided into a small drone 951, an air mobility 953, and a bird 954 in detail.

Upon the detection of the above-described hazard 9, for guidance through the display unit 65, the guidance object generation unit 6133 may generate and store a guidance object modeled in 2D or 3D in advance, generate a guidance object based on this, or generate a guidance object in real time in a shape that meets the hazard 9.

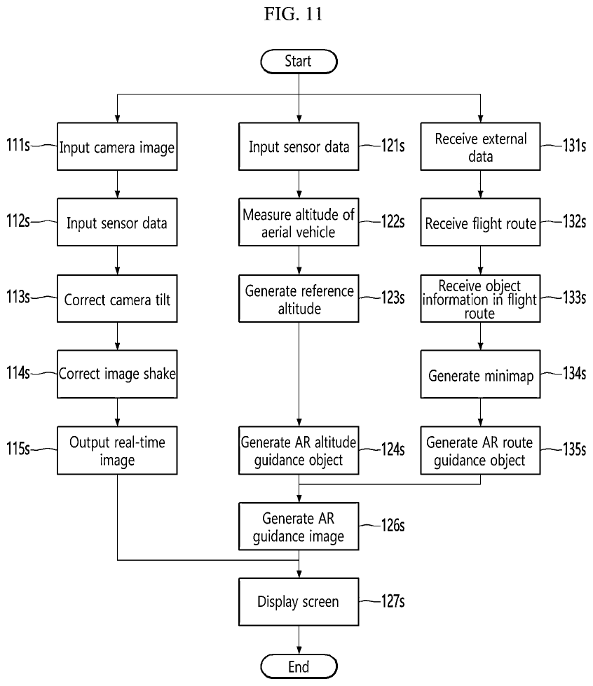

FIG. 11 is a diagram illustrating a flow of generating an augmented reality guidance screen for an aerial vehicle according to an embodiment of the present disclosure and displaying the generated augmented reality guidance screen on a screen.

Referring to FIG. 11, the image acquisition unit 62 may receive image data from a camera installed in an aerial vehicle (111s), and a slope correction unit (not illustrated) may receive data through a gyro sensor installed in the aerial vehicle (112s) to perform a tilt correction 113s of the camera based thereon. The direction of the camera may be controlled so that the camera may keep level through the tilt correction of the camera (113s).

After controlling the direction of the camera (113s), the image correction unit 616 may perform the image stabilization of the input image (114s). The image stabilization (114s) may perform the image stabilization in hardware using an optical image stabilization (OIS) gyro sensor, or the shaking may be corrected by cropping a central region of an image using an electrical image stabilization (EIS) gyro sensor.

After correcting the input image as described above, the output data generator 613 may output the real-time image to the display unit 65 (115s).

Meanwhile, the altitude measurement unit 611 may receive sensor data for AR object and information output (121s), and the altitude measurement unit 611 may measure the altitude of the aerial vehicle (122s) to generate a reference altitude (123s). Also, the output data generation unit 613 may generate an AR altitude guidance object based on the generated reference altitude (124s).

In addition, in order to output the AR object and information, the flight route determination unit 612 may receive external data for determining a flight route, such as map data and GPS data (131s), the flight route determination unit 612 may receive the flight route of the aerial vehicle (132s), and the flight route determination unit 612 may receive object information about dynamic obstacles and/or static obstacles in the flight route (133s), thereby generating a mini map (134s).

The output data generation unit 613 may generate the AR route guidance object based on the generated data of the flight route determination unit 612 (135s).

Meanwhile, the output data generation unit 613 may generate an AR guidance image using the generated AR altitude guidance object 124s and the AR route guidance object 135s (126s), and the display unit 65 may generate the AR guidance image.

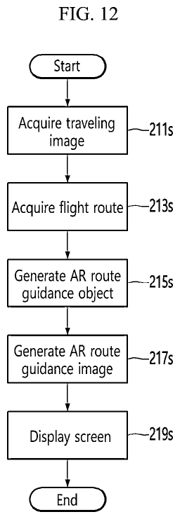

FIG. 12 is a diagram illustrating a method of providing augmented reality guidance for an aerial vehicle according to an embodiment of the present disclosure.

It will be described with reference to FIG. 12 below.

The method of providing augmented reality guidance for an aerial vehicle of this embodiment may include a traveling image acquisition step (211s), a flight route acquisition step (213s), an AR route guidance object generation step (215s), an AR route guidance image generation step (217s), and a screen display step (219s).

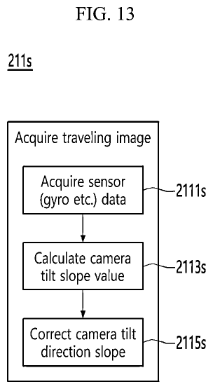

The traveling image acquisition step 211s of the image acquisition unit 61 is a step of acquiring a real-time aerial vehicle flight image by correcting the tilt of the camera and performing the image stabilization through the input camera image and sensor data as described above, which will be described later with reference to FIGS. 13 to 15.

The flight route acquisition step (213s) of the flight route determination unit 612 is a step of acquiring the flight route from the departure point of the aerial vehicle to the destination. The flight route may be generated by the flight route determination unit 612, and may include all traveling of the aerial vehicle in the flight plan including takeoff, ascending, flight, descending, landing, and ground run of the aerial vehicle.

The AR route guidance object generation step (215s) of the output data generation unit 613 is a step of generating the AR route guidance object based on the above-described flight route, and the AR route guidance object may be generated in various forms by an AR guidance object generation unit 6133.

For example, in the AR route guidance object generation step (215s), an AR route guidance object composed of a plurality of objects is generated, and the AR route guidance object may be generated by adjusting an arrangement interval of the plurality of objects according to whether the route is a curve route or a straight route.

In the AR route guidance image generation step (217s), various types of images may be generated by mapping an AR route guidance object to an aerial vehicle flight image.

For example, the AR route guidance image further includes an object indicating the yaw, pitch, and inclination in roll direction of the aerial vehicle.

The screen display step (219s) may be defined as a step of displaying the AR guidance image on the display unit 65 as described above.

FIGS. 13 to 15 are diagrams illustrating an example of a camera tilt correction according to an embodiment of the present disclosure.

It will be described with reference to FIGS. 13 to 15 below.

In the traveling image acquisition step (211s) of the image acquisition unit 61 may include a step of correcting a tilt direction slope of the camera (2115s) by acquiring camera attitude data through a gyro sensor, etc., (211s) and then calculating a tilt slope value of the camera (2113s).

A plurality of cameras may be installed as described above, and a camera that acquires a front image of an aerial vehicle may be adopted as a camera corrected through the above steps. As the tilt of the camera is corrected, the camera may be maintained horizontally to acquire an image corresponding to the traveling direction of the aerial vehicle.

That is, based on the acquired data and the calculated tilt slope value of the camera, the tilt direction slope of the camera may be corrected (2115s) so that the camera installed in front of the aerial vehicle keeps level.

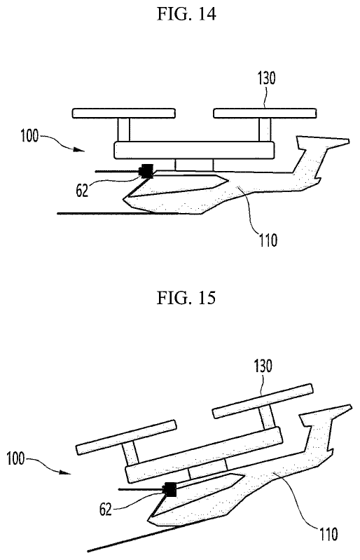

For example, the aerial vehicle 100 of this embodiment may adopt a vertical take-off and landing (VTOL) airframe having a plurality of blades 130 mounted on the body 110. In this case, when the aerial vehicle 100 performs the taking off or landing, as illustrated in FIG. 14, the image captured by the camera 62 may keep level with the main body 110.

However, as illustrated in FIG. 15, when the aerial vehicle 100 is traveling, the main body 110 is tilted unless the blade is tilted due to the characteristics of the vertical take-off and landing (VTOL) airframe. In this case, as described above, the tilt direction slope correction of the camera may be performed based on the data acquired through the gyro sensor and the tilt slope value of the camera, so that the camera may be controlled to keep a level in the traveling direction of the aerial vehicle 100.

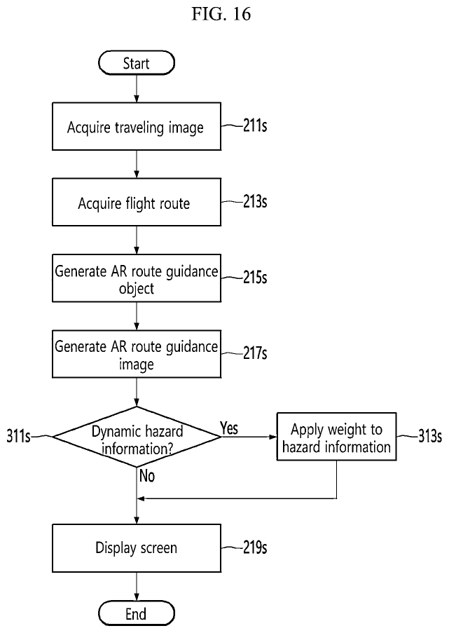

FIG. 16 is a diagram illustrating an example of AR route risk guidance according to an embodiment of the present disclosure.

In this embodiment, after the image acquisition unit 61 acquires the traveling image (211s), the flight route determination unit 612 may acquire a flight route (213s), the output data generation unit 613 may generate an AR route guidance object (215s) and generate the AR route guidance image (217s) based on the acquired flight route, and the dynamic obstacle detection unit 614 may determine whether there is dynamic hazard information (311s).

The determination of whether there is dynamic hazard information (311s) may be determined based on the dynamic hazard information mapped to the flight map data of the aerial vehicle through the dynamic obstacle detection unit 614, and the dynamic hazard may include at least one of weather information, bird flock information, and other aerial vehicles information.

Meanwhile, when the dynamic hazard is detected (311s: YES), the output data generation unit 613 may apply a weight to the hazard information (313s) to be displayed on the screen (219s). More specifically, the risk level determination unit 617 may determine the risk level by applying a weight to the hazard information, and the output data generation unit 613 may differently display the AR route guidance object differently to the display unit 65 according to the risk level.

As an example of displaying differently, the color of the AR route guidance object may be displayed differently or the transparency may be displayed differently, and various embodiments thereof will be described with reference to the drawings to be described later.

In addition, when the dynamic hazard is not detected (311s: NO), the output data generation unit 613 may display the generated AR route guidance object and image on the screen (219s).

In addition, the dynamic hazards may be replaced with immobile object hazards such as regions and buildings described in FIG. 10. It goes without saying that the screen display of the immobile object hazards may also express the AR route guidance object differently by determining the risk level like the dynamic hazards.

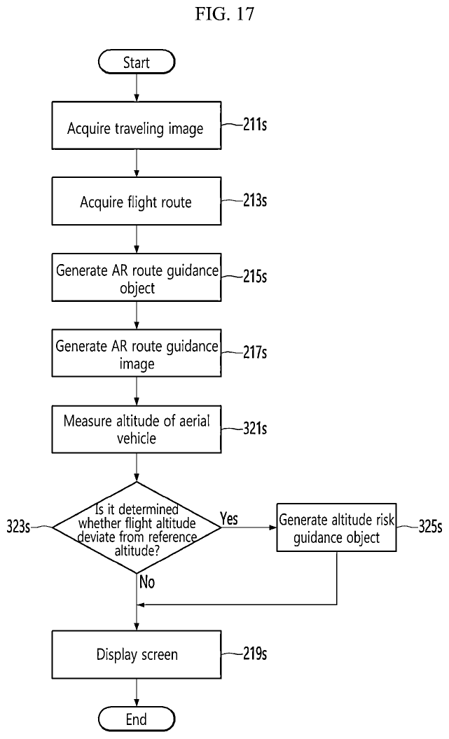

FIGS. 17 to 21 are diagrams illustrating an example of AR altitude deviation guidance according to an embodiment of the present disclosure.

It will be described with reference to FIGS. 17 to 21 below.

In this embodiment, after the image acquisition unit 61 acquires the traveling image (211s), the flight route determination unit 612 may acquire a flight route (213s), the output data generation unit 613 may generate an AR route guidance object (215s) and generate the AR route guidance image (217s) based on the acquired flight route, and the altitude measurement unit 611 may measure the altitude of the aerial vehicle (321s).

The altitude measurement of the aerial vehicle (321s) is a step of measuring the altitude of the traveling aerial vehicle through the altitude measurement unit 611, and may determine whether the measured flight altitude is out of the reference altitude range (h22-h11) (323s).

A reference altitude range h22-1h11 may be set in consideration of the altitude range h2-h1 determined by the flight corridor. Preferably, the reference altitude range h22-1h11 may be defined within the altitude range h2-h1 determined by the flight corridor.

More specifically, the reference altitude range h22-h11 may be defined as an appropriate altitude range for stable flight within the altitude range h2-h1 determined by the flight corridor of the aerial vehicle 100.

Accordingly, when the measured altitude of the aerial vehicle 100 approaches the lower limit altitude h22 or the upper limit altitude h11 of the reference altitude range h22-h11, the guidance object generation unit 6133 may generate the AR altitude risk guidance object indicating altitude danger.

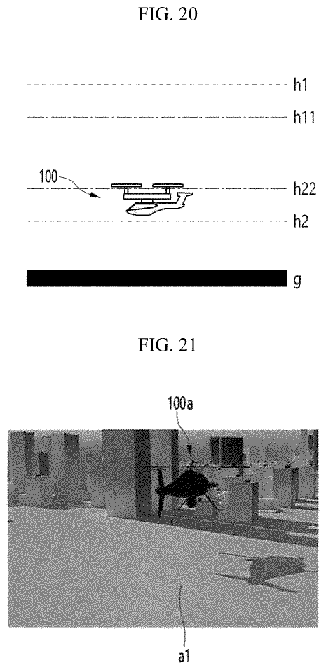

Alternatively, as illustrated in FIG. 20, when the altitude of the aerial vehicle 100 is out of the reference altitude range h22-h11, the guidance object generation unit 6133 may generate the AR altitude danger guidance object indicating the altitude danger.

The output data generation unit 613 may generate the AR altitude risk guidance object in which the measured flight altitude of the aerial vehicle 100 approaches the upper limit altitude h11 or the lower limit altitude h22 of the reference altitude or is out of the reference altitude range h22-h11 and display the generated AR altitude risk guidance object on the screen through the display unit 65 (219s).

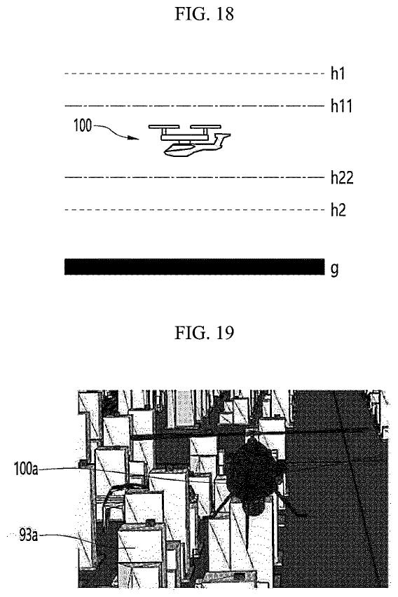

FIGS. 18 and 19 illustrate a case in which the aerial vehicle 100 travels within the reference altitude range h22-h11. In this case, a separate altitude risk guidance object is not generated on the display unit 65.

FIGS. 20 and 21 illustrate the case in which the aerial vehicle 100 is out of the reference altitude range h22-h11, and more specifically, in this embodiment, the aerial vehicle 100 is out of the lower limit altitude h2 of the reference altitude.

Accordingly, in this case, the output data generation unit 613 may generate an AR altitude risk guidance object a1 indicating the altitude risk and display the generated AR altitude risk guidance object a1 on the display unit 65. The AR altitude risk guidance object a1 of this embodiment is displayed as an opaque red object at a location corresponding to the lower limit altitude h2 of the reference altitude or the corresponding location between the lower limit altitude h2 of the reference altitude and the object 100a indicating the aerial vehicle, but it is not necessarily limited to this embodiment, and it goes without saying that the color of the AR altitude risk guidance object may be displayed differently or the transparency may be adjusted as it approaches the upper limit altitude h1 or the lower limit altitude h2 of the reference altitude.

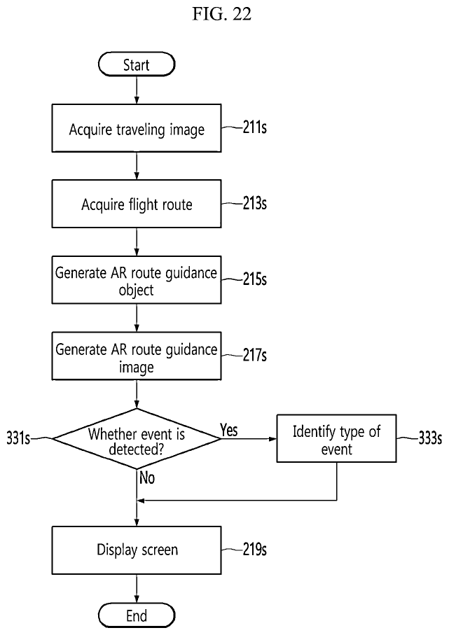

FIG. 22 is a diagram illustrating an example of AR event guidance according to an embodiment of the present disclosure.

In this embodiment, after the image acquisition unit 62 acquires the traveling image (211s), the flight route determination unit 612 may acquire a flight route (213s), the output data generation unit 613 may generate an AR route guidance object (215s) and generate the AR route guidance image (217s) based on the acquired flight route, and the event identification unit 619 may determine whether the event is detected (331s).

When the event is detected (331s: YES), the type of event may be identified through the event identification unit 613 (333s), and the output data generation unit 613 may display an AR event guidance object indicating an event on the AR route guidance image according to the identified type of event (219s).

The detection of the event may be performed through the static obstacle detection unit 614 and the dynamic obstacle detection unit 615, and the event may include at least one of a bird flock event, a collision risk building, a vertiport, and a prohibited area.

That is, the event is an object that causes an off-nominal situation that may occur during the flight of the aerial vehicle, and may be defined as including dynamic obstacles and static obstacles as classified in FIG. 10 described above.

An example of displaying the AR event guidance object indicating an event according to the identified type of event will be described later with reference to the drawings.

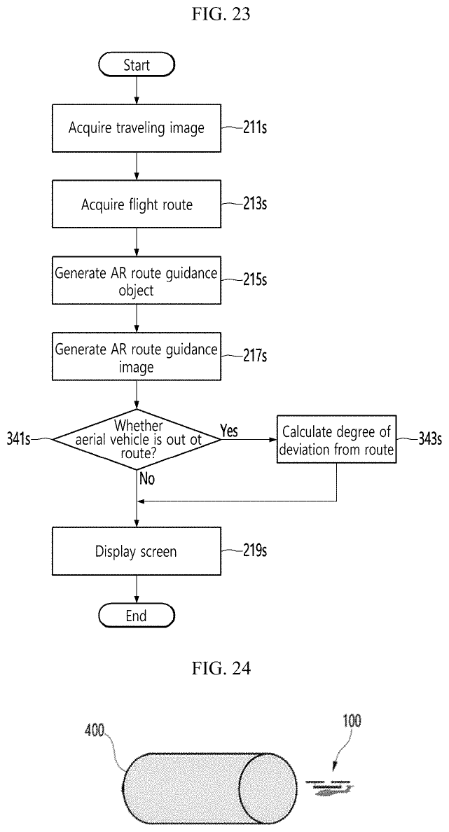

FIGS. 23 to 27 are diagrams illustrating an example of AR route deviation guidance according to an embodiment of the present disclosure.

In this embodiment, after the image acquisition unit 62 acquires the traveling image (211s), the flight route determination unit 612 may acquire a flight route (213s), the output data generation unit 613 may generate an AR route guidance object (215s) and generate the AR route guidance image (217s) based on the acquired flight route, and the flight route determination unit 612 may determine whether the aerial vehicle deviates from the route (341s).

Regarding whether the aerial vehicle deviates from the route in the step 341s of determining whether the aerial vehicle deviates from the route, it may be determined whether the traveling aerial vehicle deviates from the flight route by comparing the measured location of the aerial vehicle with the flight route generated by the flight route determination unit 612.

The flight route may be defined as any one of the altitude range h2-h1 defined by the flight corridor in FIGS. 18 and 20 or the reference altitude range h22-1h11 defined as an appropriate altitude range for stable traveling within the flight corridor of the aerial vehicle 100.

That is, the flight route determination unit 612 may determine whether the aerial vehicle is out of the altitude range h2-h1 or the reference altitude range h22-h11 of the flight corridor, and the AR route guidance object may be displayed differently according to whether the aerial vehicle deviates from the route.

More specifically, when the aerial vehicle deviates from the route (341s: YES), the degree of deviation from the route is calculated (343s), and the AR route guidance object may be displayed differently according to the degree of deviation from the route. For example, the color of the AR route guidance object may be displayed differently or the transparency of the AR route guidance object may be adjusted and displayed according to the degree of deviation from the route.

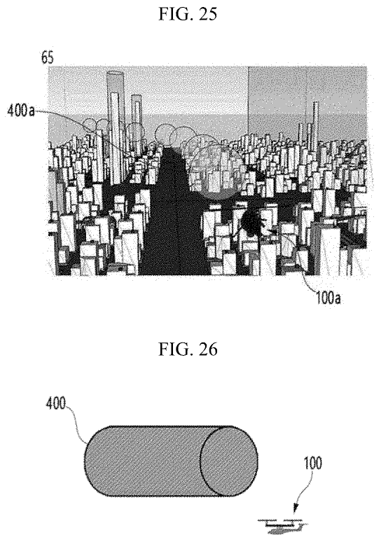

FIG. 24 is a diagram illustrating a case where the aerial vehicle 100 does not deviate from a flight route 400, and FIG. 25 is a diagram illustrating an AR route guidance object display in the situation of FIG. 24.

As the flight route 400, as described above, any one of the altitude range h2-h1 defined as a flight corridor or the reference altitude range (h22-h11) for stable traveling of the aerial vehicle 100 may be adopted.

When the aerial vehicle 100 travels within the flight route 400, the output data generation unit 613 may generate an object 100a indicating the aerial vehicle and an AR route guidance object 400a indicating the flight route, and display the generated object 100a and AR route guidance object 400a on the display unit 65. In this case, the output data generation unit 613 may ensure visibility of a pilot by lightening the color of the AR route guidance object 400a indicating the flight route and increasing transparency.

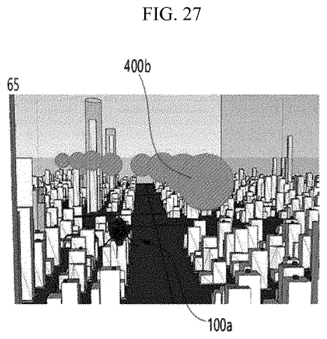

FIG. 26 is a diagram illustrating a case where the aerial vehicle 100 does not deviate from the flight route 400, and FIG. 27 is a diagram illustrating the AR route guidance object display in the situation of FIG. 26.

As illustrated in FIG. 26, when the aerial vehicle 100 deviates from the flight route 400, an AR route guidance object 400b indicating the flight route displayed on the display unit 65 through the output data generation unit 613 may have lower transparency and a darker color than the AR route guidance object 400a indicating the flight route displayed on the display unit 65 through the output data generation unit 613 when the aerial vehicle 100 does not deviate from the flight route 400 as illustrated in FIG. 25.

Therefore, when the aerial vehicle 100 deviates from the flight route 400 and travels, the output data generation unit 613 may more effectively notify the pilot of the deviation from the flight route by darkening the color and lowering the transparency of the AR route guidance object 400b indicating the flight route on the display unit 65.

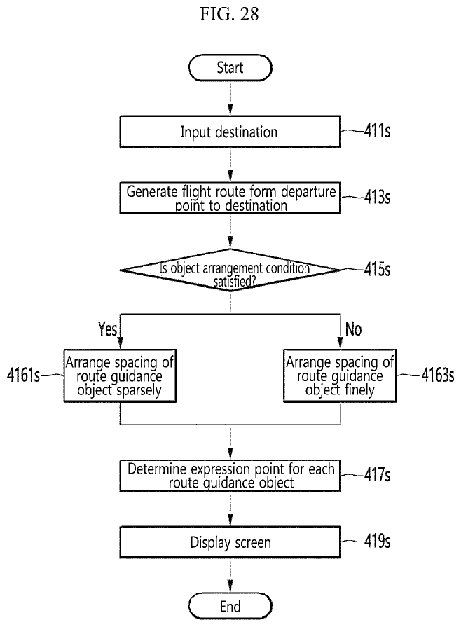

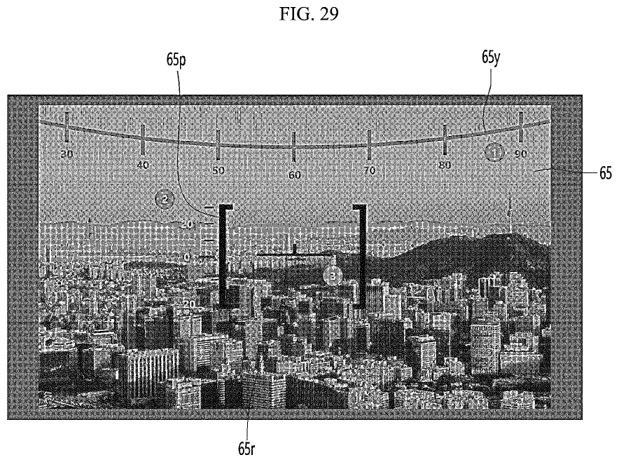

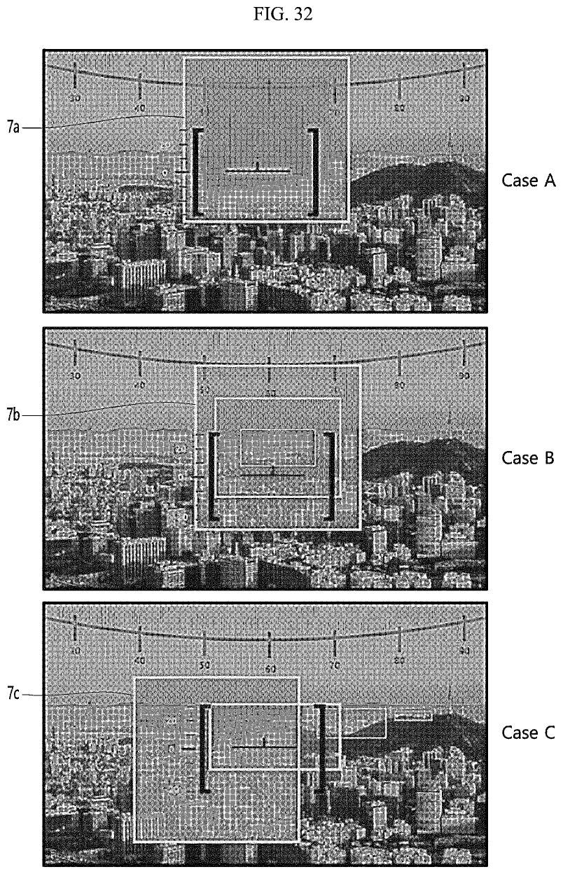

FIG. 28 is a diagram illustrating a method of displaying an AR route guidance object according to an embodiment of the present disclosure. FIG. 29 is a diagram illustrating a reference object displayed on a display unit according to an embodiment of the present disclosure, FIG. is a diagram illustrating a plurality of AR route guidance objects viewed from one side, FIG. 31 is a diagram illustrating a plurality of AR route guidance objects viewed from the top, and FIG. 32 is a view illustrating an example in which a plurality of AR route guidance objects are displayed on a display unit.

It will be described with reference to FIGS. 28 to 32 below.

The flight route determining unit 612 may generate a flight route from the departure point to the destination (413s) based on the input of the destination before the flight of the aerial vehicle 100 (411s). The output data generation unit 613 may determine whether the arrangement condition of the AR route guidance object is satisfied based on the generated flight route (415s), arrange the interval of the AR route guidance object differently depending on whether the AR route guidance object is satisfied (4161s, 4163s), and determine an expression point for each AR route guidance object (417s) to display the AR route guidance object on the display unit 65 (419s).

As will be described later, the arrangement condition of the AR route guidance object may be based on the distance between the aerial vehicle 100 and the AR route guidance object displayed on the display unit 65. Alternatively, as will be described later, it may be based on whether the flight route image of the aerial vehicle 100 is a straight route or a curved route.

Referring to FIG. 29, a reference object for indicating the attitude of the aerial vehicle may be displayed on the display unit 65. More specifically, the reference object may include an object 65y indicating the inclination of the aerial vehicle in the yaw direction, an object 65p indicating the inclination in the pitch direction, and an object 65r indicating the inclination in the roll direction. The output data generation unit 613 may generate and display the AR route guidance object on the display unit 65 on which the reference object is displayed.

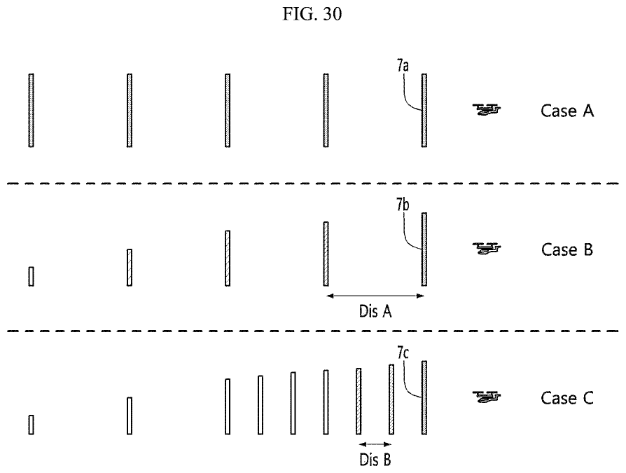

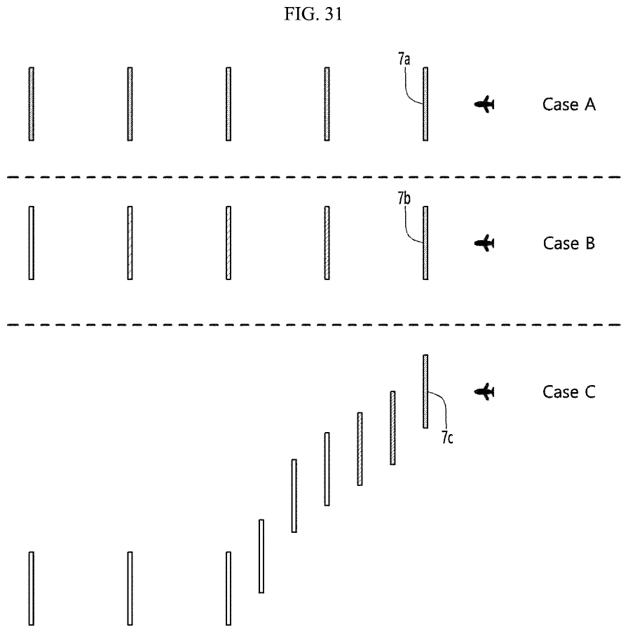

Meanwhile, the output data generation unit 613 may determine whether the AR route guidance object satisfies the arrangement condition (415s). For example, as in case A of FIGS. 30 to 32, when a plurality of AR route guidance objects 7a are expressed in the same size, same interval, and same transparency and/or color, since several AR route guidance objects overlap each other and are displayed on the display unit 65, a pilot's view may be hindered.

Therefore, when the flight route is a straight route as in case B of FIGS. 30 to 32, the output data generation unit 613 may generate a shorter vertical height of the AR route guidance objects as the distance from the aerial vehicle 100 increases, and may lower the transparency of the AR route guidance objects as the distance from the aerial vehicle 100 increases and display them on the display unit 65 (7b). For example, the distance between each AR route guidance object may be displayed at intervals of 200 m.

Alternatively, when the flight route is a curved route as in case C of FIGS. 30 to 32, the output data generation unit 613 may generate a shorter vertical height of the AR route guidance objects as the distance from the aerial vehicle 100 increases, and may lower the transparency of the AR route guidance objects as the distance from the aerial vehicle 100 increases and display them on the display unit 65 (7b).

For example, the distance between the objects in the curved section may be displayed relatively densely compared to a straight route such as case B, and in this example, the distance between the respective AR route guidance objects may be displayed at 50 m intervals.

In addition, as described above, when a plurality of AR route guidance objects overlap, the pilot's view may be hindered, so the importance of the route line may be displayed to the pilot by adjusting the transparency. For example, after transparency of N AR route guidance objects closest to the aerial vehicle is adjusted to a low level as the N AR route guidance objects move away from the aerial vehicle, in the case of the remaining objects, the transparency of the AR route guidance object is adjusted to a high level, so it is possible to secure the visible distance by displaying only the outline of the AR route guidance object.

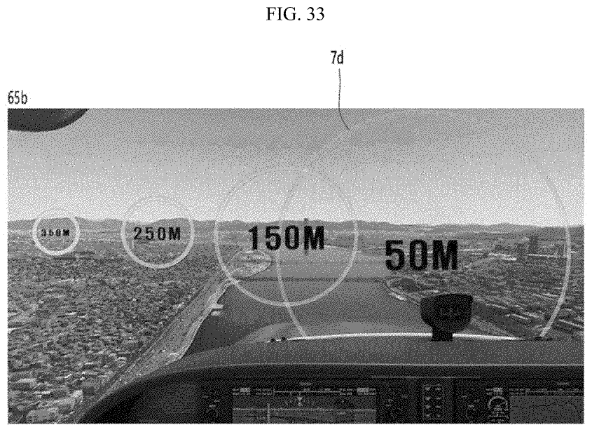

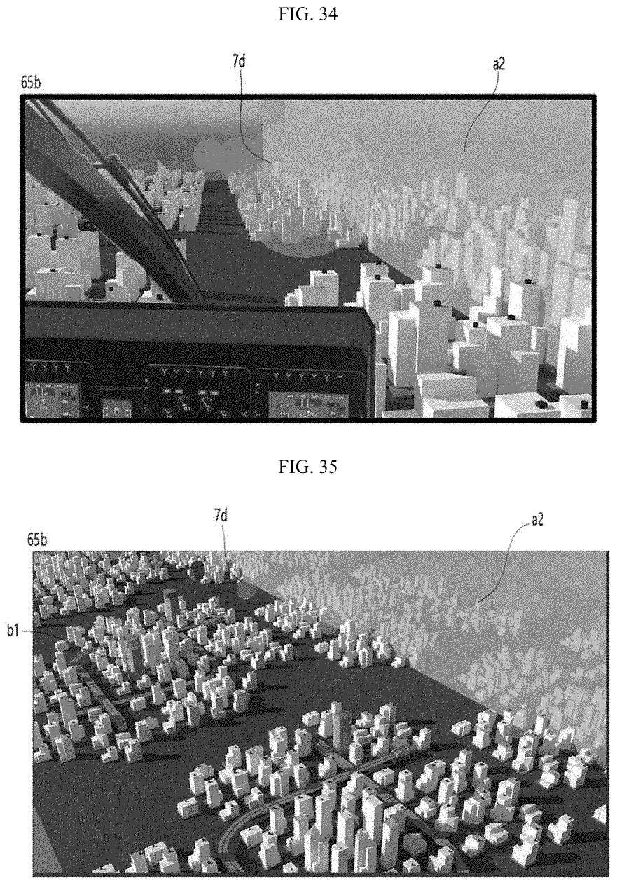

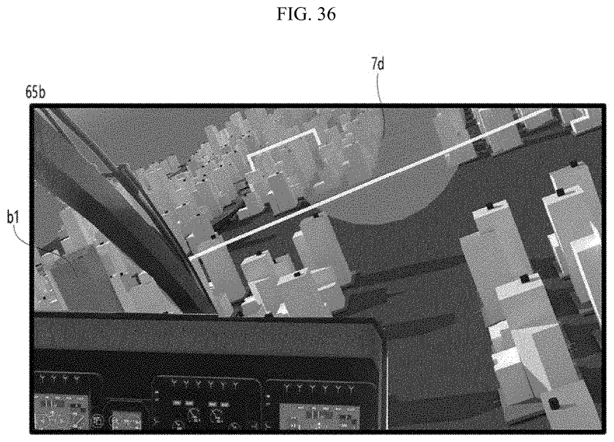

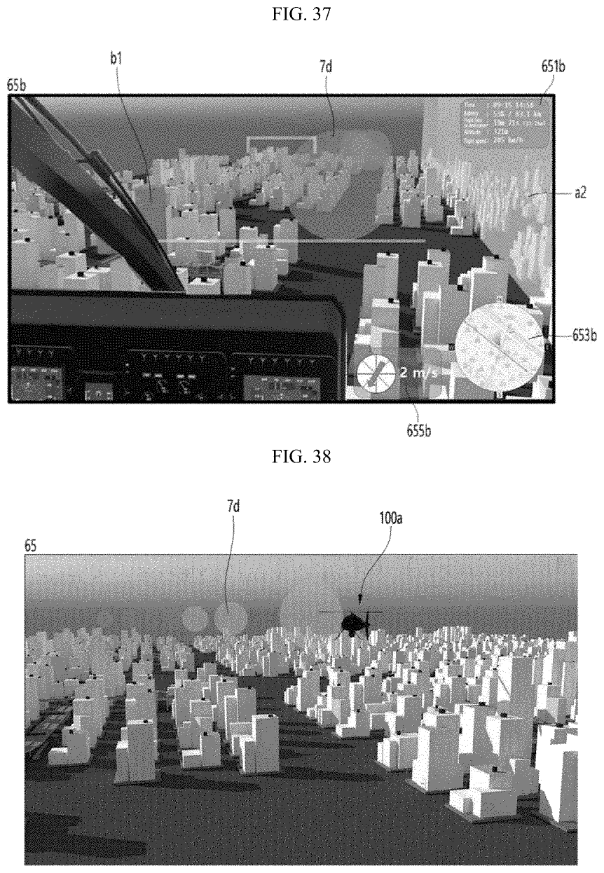

FIGS. 33 to 37 are diagrams illustrating a method of displaying an AR screen according to a second embodiment of the present disclosure.

The output data generation unit 613 may generate a plurality of AR route guidance objects 7d and project the generated AR route guidance objects 7d onto a windshield 65b of the aerial vehicle 100 through the display unit 65. More specifically, in order to output the AR route guidance object 7d to the windshield 65b, the display unit 65 may project display data for displaying the AR route guidance object generated by the output data generation unit 613 onto the windshield 65b.

Meanwhile, the output data generation unit 613 may generate the AR route guidance objects 7d in a circular shape, and increase the transparency of the AR route guidance objects 7d as they move away from the aerial vehicle 100 through the display unit 65 and project the AR route guidance object 7d onto the windshield 65b.

In addition, the output data generation unit 613 may numerically display how far the generated AR route guidance objects 7d are located from the aerial vehicle.

In addition, the output data generation unit 613 may generate objects indicating obstacles detected through the obstacle detection units 614 and 615 and projects the generated objects onto the windshield 65b of the aerial vehicle 100 through the display unit 65.

For example, on the windshield 65b, an AR object a2 indicating a restricted flight area may be displayed, and an AR object b1 indicating a static obstacle may be displayed.

In addition, on the windshield 65b, an object 651b numerically guiding a time required to reach a destination on the flight route generated by the flight route determination unit 612, a fuel or battery condition of the aerial vehicle, an altitude and a speed of the aerial vehicle, etc., may be displayed, an object 653b displaying data generated through the output data generation unit 613 on 2D, etc., may be displayed, and an object 655b indicating a wind direction and a wind speed may be displayed.

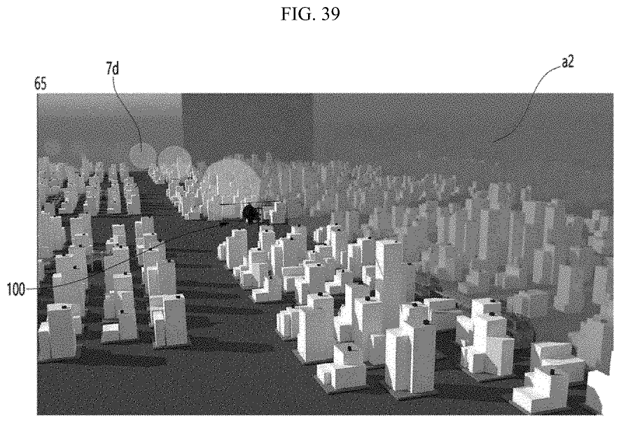

FIGS. 38 and 39 are diagrams illustrating a method of displaying an AR screen according to a third embodiment of the present disclosure.

The output data generation unit 613 may generate a plurality of objects and display the generated objects through the display unit 65, and as the displayed objects, an object 100a indicating an aerial vehicle, the AR route guidance object 7d, the AR object a2 indicating the restricted flight area, and an AR object b1 indicating a static obstacle, etc., may be exemplarily displayed.

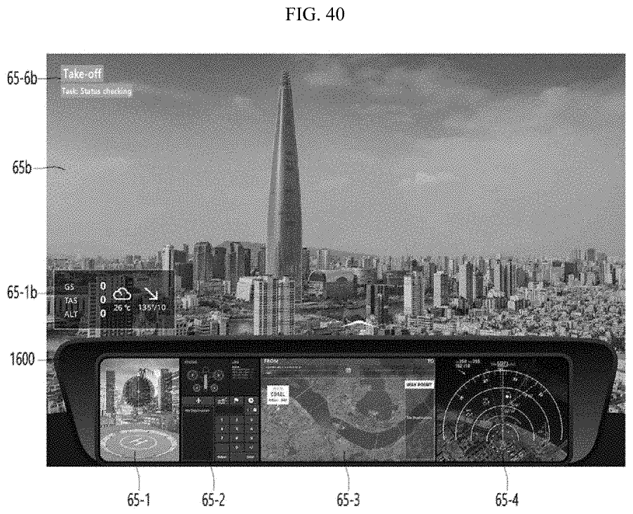

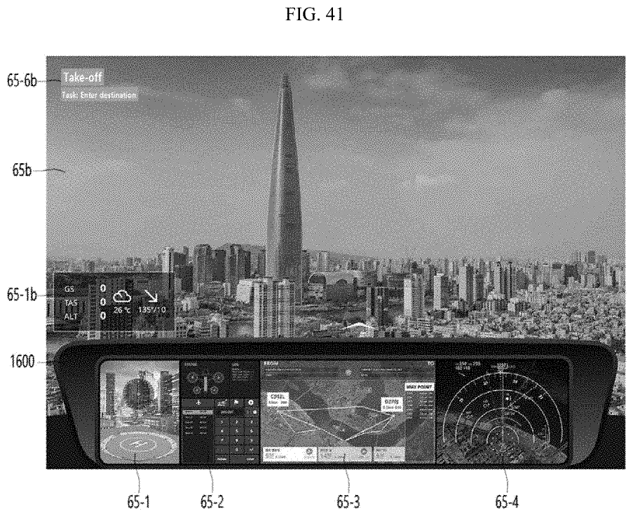

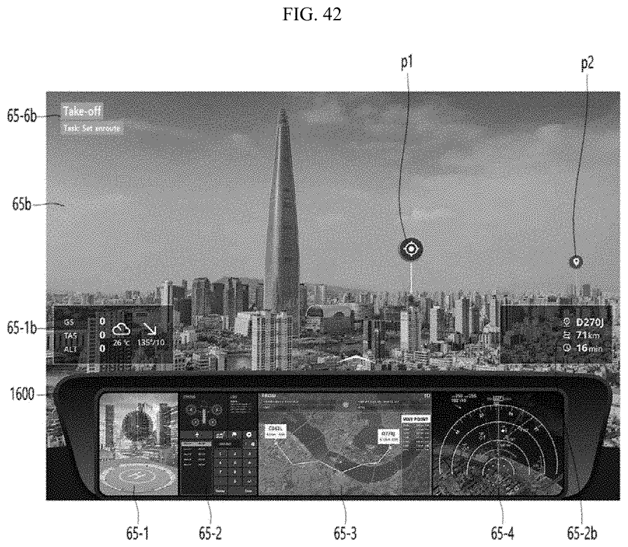

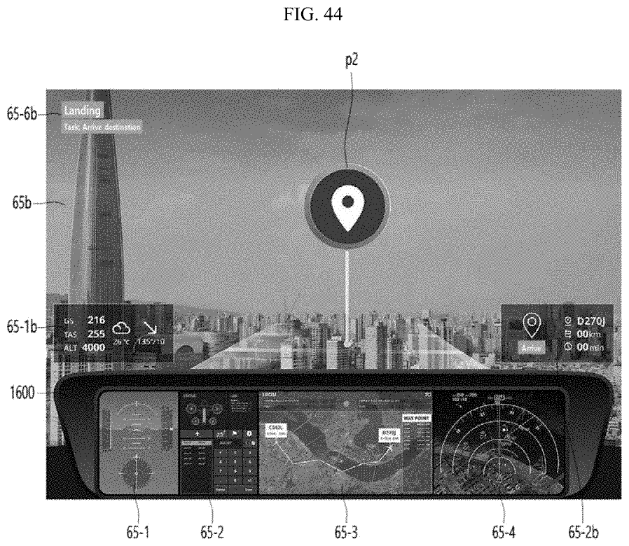

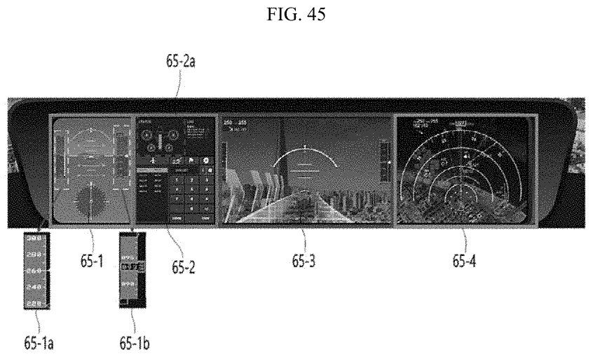

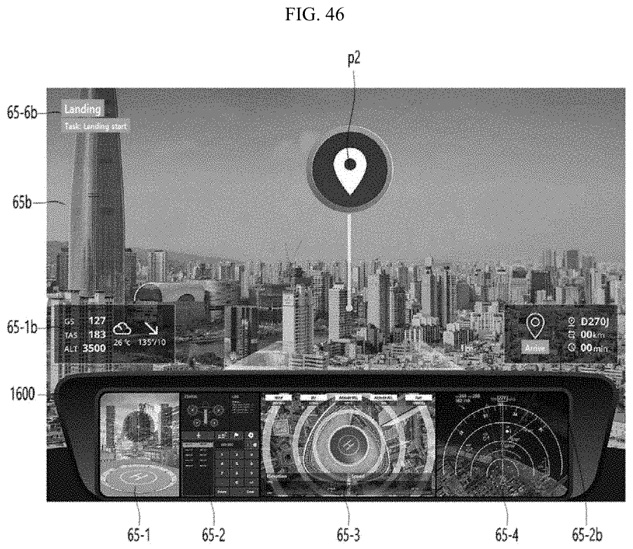

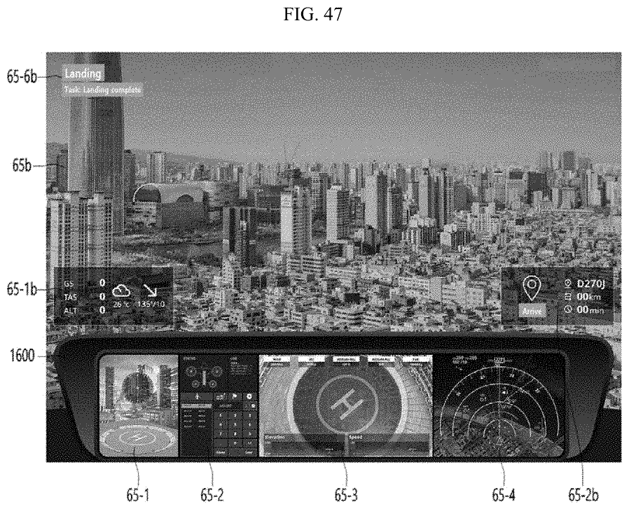

FIGS. 40 to 44 are diagrams illustrating AR guidance objects displayed during the take-off and landing of the UAM aerial vehicle according to a fourth embodiment of the present disclosure, FIG. 45 is a diagram illustrating a secondary flight display of FIG. 44, and FIGS. 46 and 47 are diagrams illustrating a landing guidance screen of a surround view monitor method according to a fourth embodiment of the present disclosure.

As illustrated in FIGS. 40 to 47, the display of the UAM aerial vehicle may include a primary flight display 65b that is transmitted through the windshield of the UAM aerial vehicle and displays various types of information related to UAM flight to a pilot and/or passengers in the AR form, and a secondary flight display 1600 that displays various types of flight assist information necessary for the UAM flight to a UAM pilot on a plurality of displays.

A UAM flight assist information object 65-1b indicating information on weather, wind speed, data processing unit 61, etc., transmitted from the UAM operator 154 and a UAM flight route auxiliary information object 65-2b indicating information such as the time required to reach the destination, the distance to the destination, etc., measured through the data processing unit 61 may be projected through the display unit 65 and displayed on the primary flight display 65b.

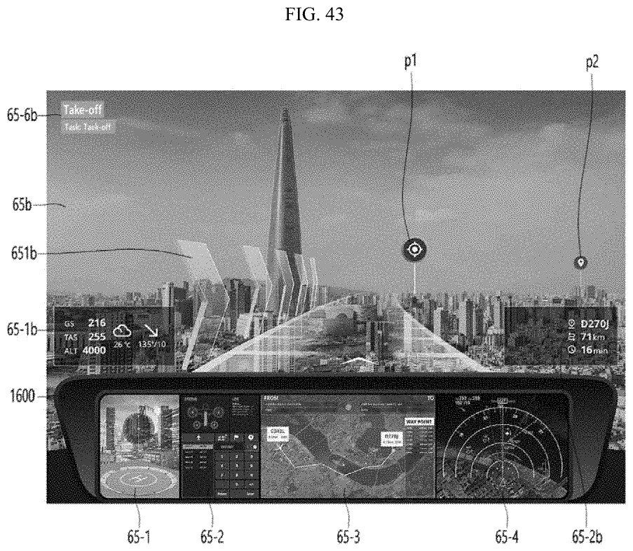

More specifically, referring to FIG. 43, the UAM flight assist information 65-1b may include a ground speed (GS) indicated by “216”, an altitude (ALT) indicated by “255”, and a true airspeed (TAS) indicated by “4000”, and may further include temperature and weather and wind direction and speed.

The UAM flight route auxiliary information 65-2b may include a location of a destination indicated by “D270J”, a distance to a destination indicated by “71KM”, an estimated time to a destination indicated by “16 min”, a turn direction, and a distance to a turn point.

In addition, a guidance object (waypoint, p1) indicating a waypoint generated through the output data generation unit 613 and the display unit 65, a guidance object (vertiport, p2) indicating a destination, and an AR route guidance object 65-3b may be displayed on the primary flight display 65b.

In addition, a UAM flight-related event guidance message 65-6b may be displayed on the primary display 65b. Here, the UAM flight-related event guidance message 65-6b may include a notification of the current situation of the UAM aerial vehicle indicated as “take-off, flight, landing” and a detected dangerous object indicated as “Task: building occurrence notification”, and the notification of the dangerous objects will be described later.

Meanwhile, the secondary flight display 1600 may be implemented in the form of a multi-function display (MFD). The secondary flight display 1600 may include a first display 65-1, a second UAM display 65-2, a third display 65-3, and a fourth display 65-4.

The first display 65-1 may display an image for assisting take-off and landing of an aerial vehicle, an image for attitude control of the UAM aerial vehicle, etc.

More specifically, referring to FIGS. 40 to 43, the output data generating unit 613 may generate an AR auxiliary guidance image and display the generated AR auxiliary guidance image on the first display 65-1 when the UAM aerial vehicle takes off, referring to FIG. 44, the output data generation unit 613 may generate an image for attitude control, etc., of the UAM aerial vehicle and display the generated image on the first display 65-1 when the UAM aerial vehicle takes off, and referring to FIGS. 45 and 46, the output data generation unit 613 may generate the AR auxiliary guidance image and display the generated AR auxiliary guidance image on the first display 65-1 when the UAM aerial vehicle lands.

Referring to FIG. 45, a UAM electronic attitude direction indicator (EADI) including horizontal lines and vertical lines may be included in the image displayed on the first display 65-1 during the take-off of the UAM aerial vehicle

The horizontal lines in the electronic attitude meter may provide the UMA pitch information, the vertical lines may provide the UAM roll information, and when both the UAM's pilot or UAM flight are in autopilot mode, the UAM's flight computer should generate various types of control information to perform the flight according to the provided information.

On the left side of the first display 65-1, a speed indicator 65-1a displaying the current flight speed of the UAM may be displayed overlaid with EADI, and on the right side, a glide scope indicator 65-1b may be displayed overlaid with the EADI.

Meanwhile, the UAM status indicator information may be displayed on the second display 65-2, and exemplarily, the information displayed on the second display 65-2 may include a UAM's propulsion unit status indicator 65f-a.

Reference number 65-2a shows that the number of UAM propulsion units is four, but this only shows a current status of each propulsion unit in real time when the UAM is a quadcopter according to one embodiment, and it is natural that they are displayed differently depending on the number of propulsion units mounted on the UAM.

Meanwhile, a third display 65-3 displays a navigation map according to a route pre-assigned to the UAM. In the present disclosure, the route, waypoint, etc., of the UAM are displayed in an AR method. Through the third display 65-3, the pilot and/or passengers of the UAM may intuitively know that the UAM is flying normally without deviating from a predetermined route.

On the other hand, the fourth display 65-4 may display surrounding obstacles and/or surrounding terrain, etc., that are sensed through non-vision sensors mounted on the UAM, and even when visibility flight is difficult due to fog or the like, the information for assisting the safe flight of the UAM may be provided.

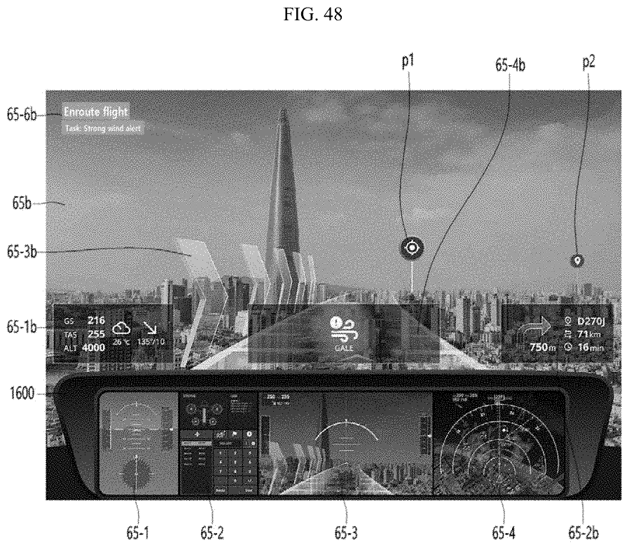

FIGS. 48 to 58 are diagrams illustrating a method of displaying a UAM flight-related event guidance object according to the fourth embodiment of the present disclosure.

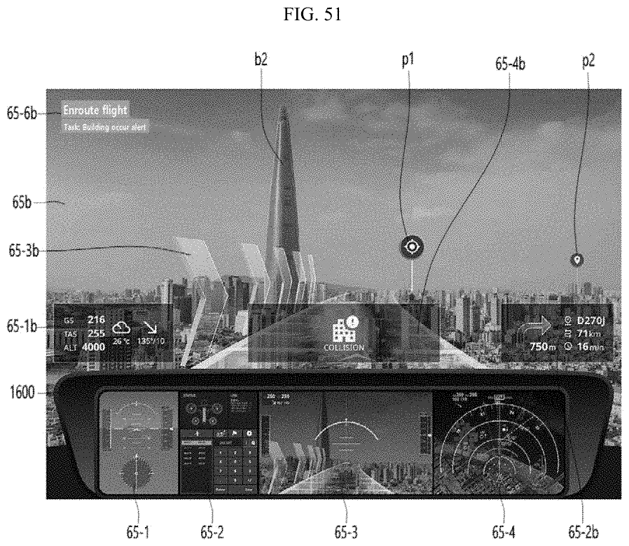

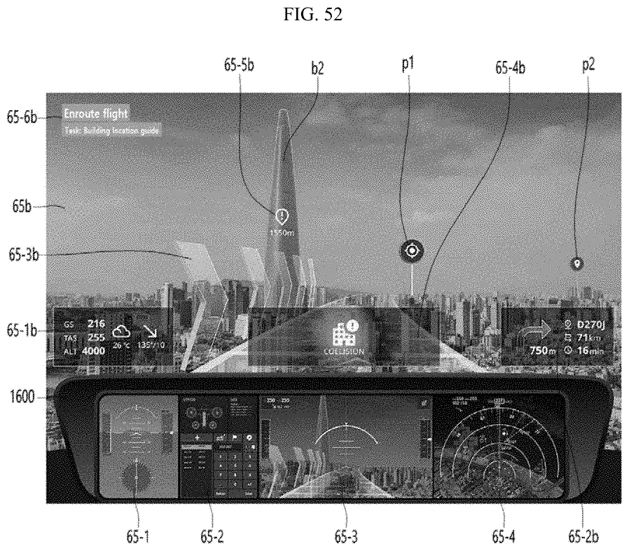

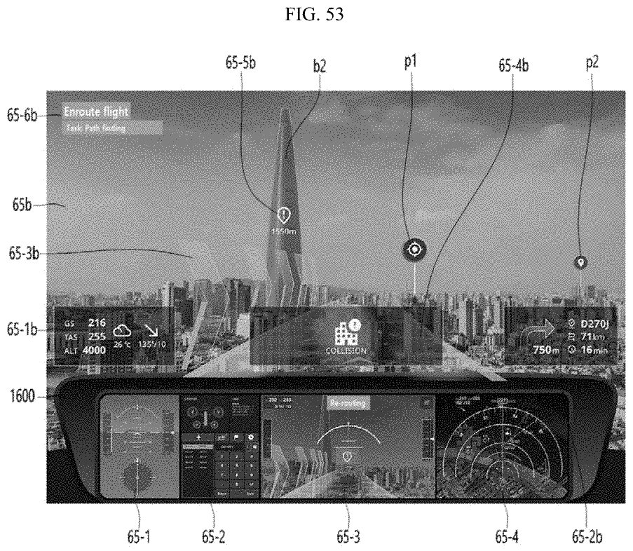

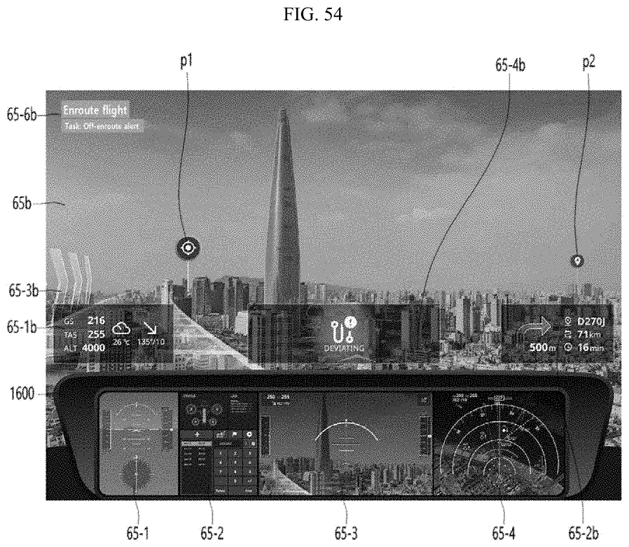

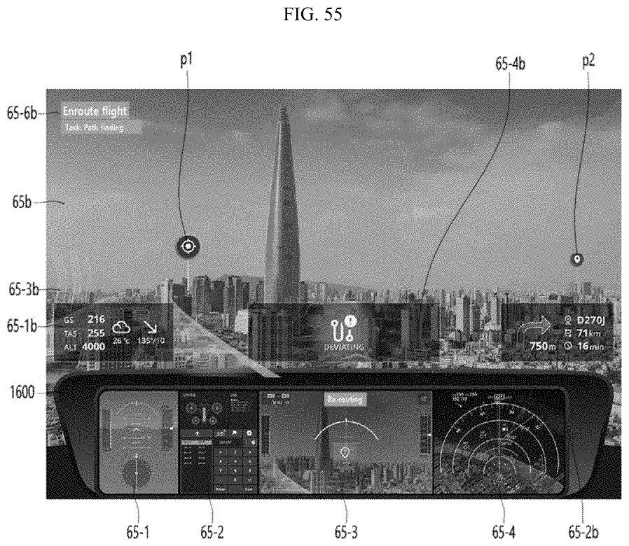

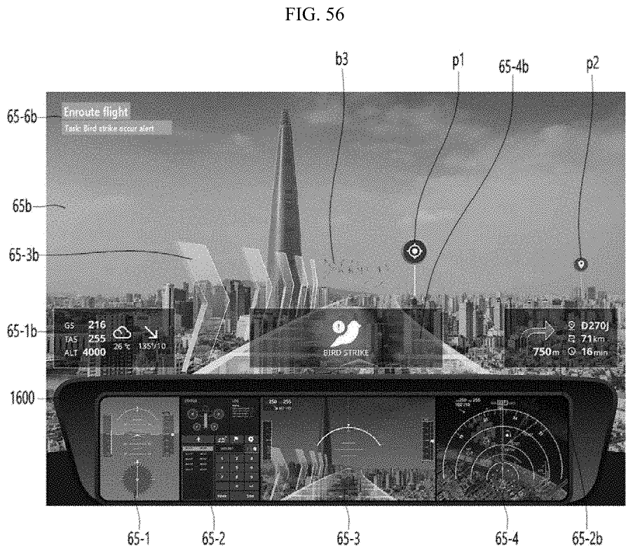

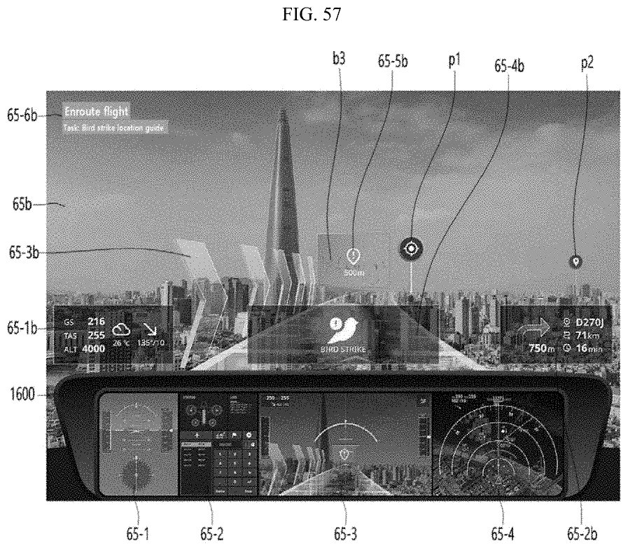

More specifically, FIGS. 48 to 50 are diagrams illustrating a method of displaying an AR object when a strong wind occurs on a flight route, FIGS. 51 to 53 are diagrams illustrating a method of displaying an AR object when a building is located on a flight route, FIGS. 54 and 55 are views illustrating a method of displaying an AR object when the UAM aerial vehicle deviates from a flight route, and FIGS. 56 to 58 are diagrams illustrating the AR object display method when there is a risk of bird strike due to a bird existing on the flight route.

Referring to FIGS. 48 to 58, when the UAM flight-related event occurs, UAM flight-related event guidance objects 65-4b and 65-5b may be displayed on the primary display 65b. For example, a UAM flight-related event guidance object 661c may be displayed as an icon indicating the type of the detected dangerous object.

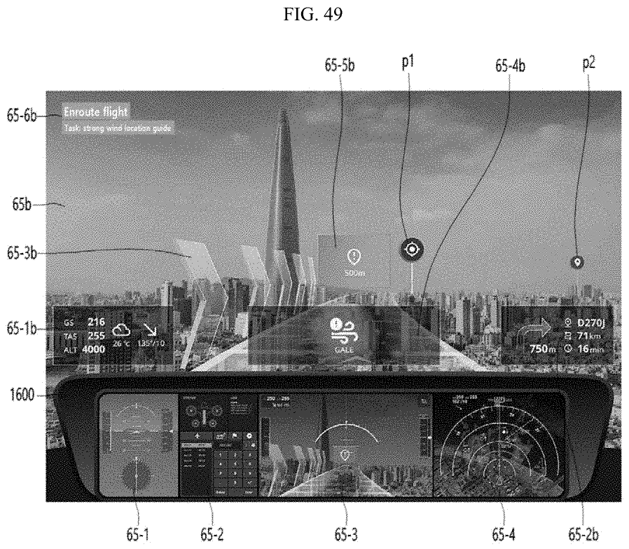

As illustrated in FIG. 48, when a strong wind occurs on the flight route of the UAM aerial vehicle, the icon-shaped UAM flight-related event guidance object 65-4b generated through the output data generation unit 613 may be displayed on the primary flight display 65b. In addition, as illustrated in FIG. 49, an object 65-5b indicating a distance to a point where the strong wind occurred may be displayed on the primary flight display 65b.

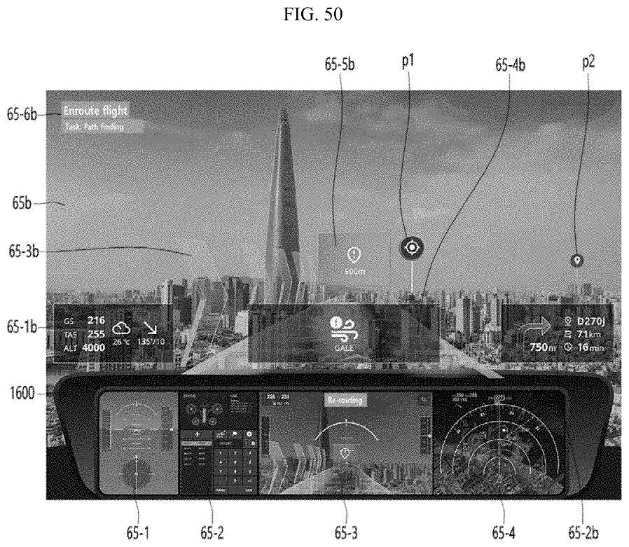

As illustrated in FIG. 50, the AR route guidance object 65-3b may be displayed in a different color from when an event does not occur in order to intuitively inform the pilot and/or passengers whether the event has occurred.

Meanwhile, as illustrated in FIG. 51, when a building b2 exists on the flight route of the UAM aerial vehicle, the icon-shaped UAM flight-related event guidance object 65-4b generated through the output data generation unit 613 may be displayed on the primary flight display 65b. In addition, as illustrated in FIG. 52, the object 65-5b indicating a distance to a building and/or a height of a building may be displayed on the primary flight display 65b.

As illustrated in FIG. 53, the AR route guidance object 65-3b may be displayed in a different color from when an event does not occur in order to intuitively inform the pilot and/or passengers whether the event has occurred.

Meanwhile, as illustrated in FIG. 54, when the UAM aerial vehicle deviates from the flight route, the icon-shaped UAM flight-related event guidance object 65-4b generated through the output data generation unit 613 may be displayed on the primary flight display 65b.

As illustrated in FIG. 55, the AR route guidance object 65-3b may be displayed in a different color from when an event does not occur in order to intuitively inform the pilot and/or passengers whether the event has occurred.

Meanwhile, as illustrated in FIG. 56, when a risk of bird strike exists on the flight route of the UAM aerial vehicle, the icon-shaped UAM flight-related event guidance object 65-4b generated through the output data generation unit 613 may be displayed on the primary flight display 65b. In addition, as illustrated in FIG. 57, the object 65-5b indicating a distance to a point b3 where the risk of bird strike exists may be displayed on the primary flight display 65b.

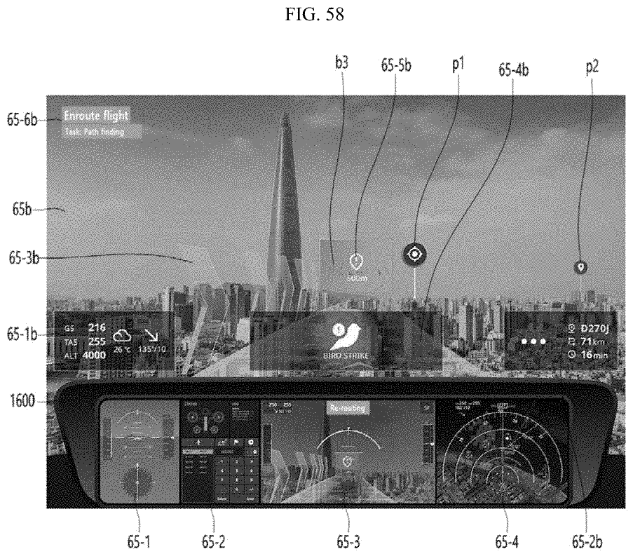

As illustrated in FIG. 58, the AR route guidance object 65-3b may be displayed in a different color from when an event does not occur in order to intuitively inform the pilot and/or passengers whether the event has occurred.

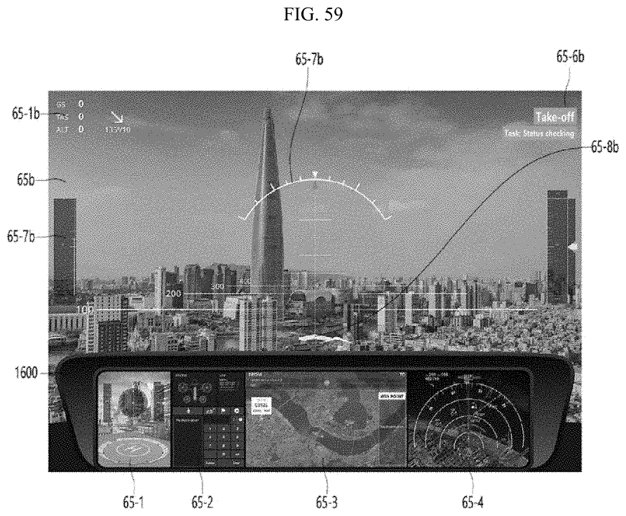

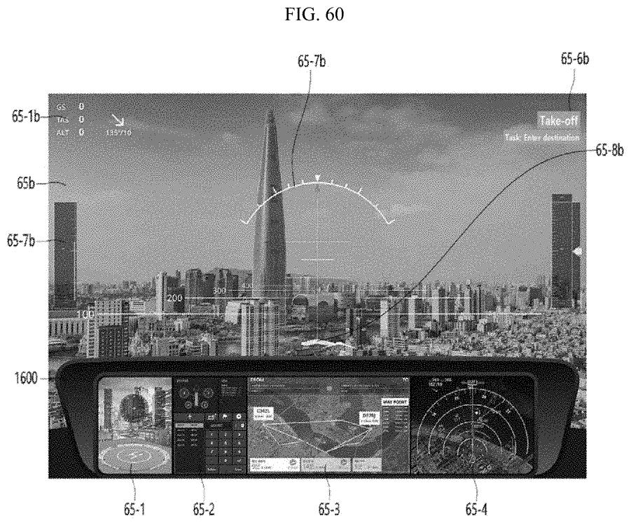

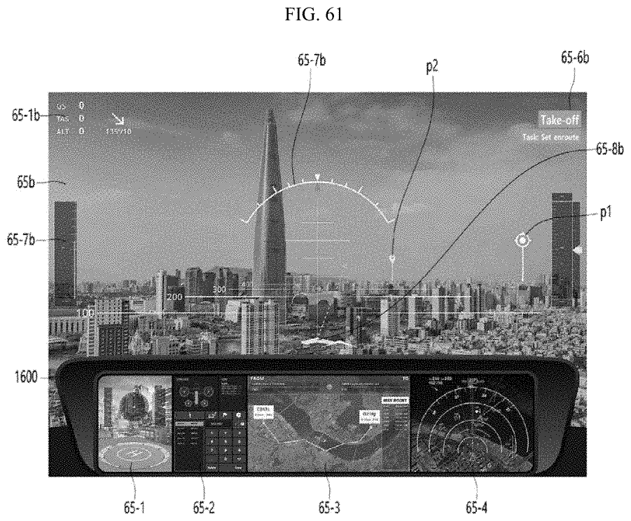

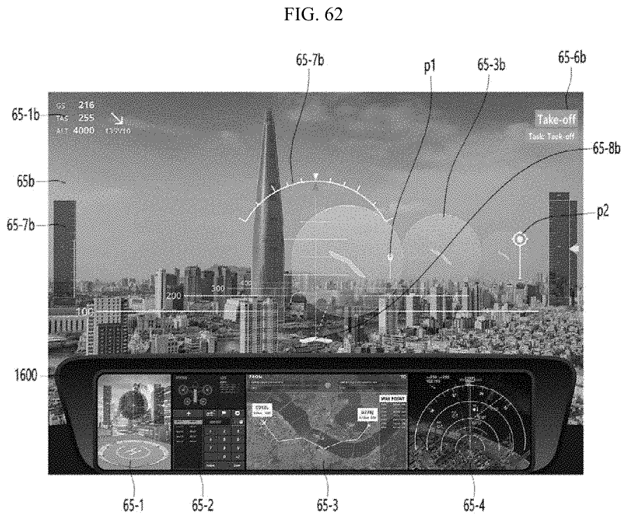

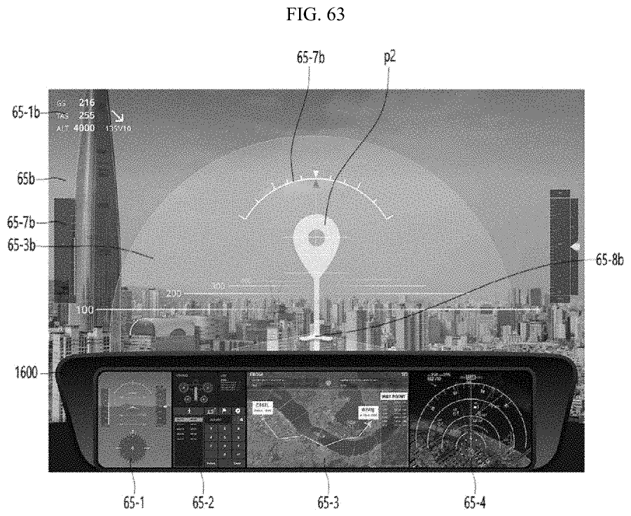

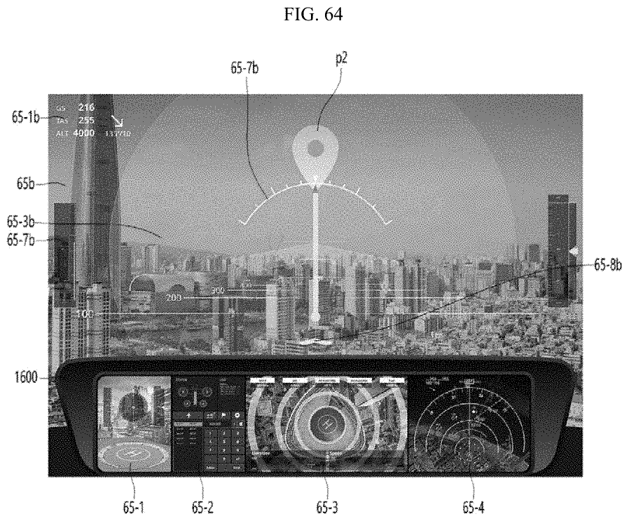

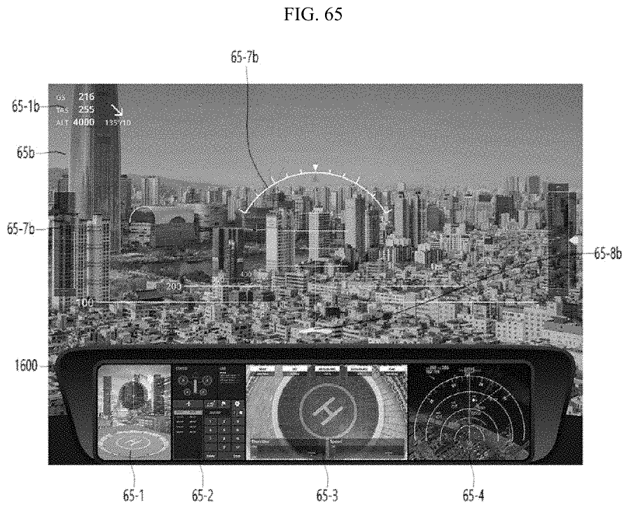

FIGS. 59 to 63 are diagrams illustrating AR guidance objects displayed during the take-off and landing of the UAM aerial vehicle according to a fifth embodiment of the present disclosure, FIGS. 64 and 65 are diagrams illustrating a landing guidance screen of a surround view monitor method according to the fifth embodiment of the present disclosure.

Hereinafter, a description will be made with reference to FIGS. 59 to 65, and contents overlapping with those of the above-described fourth embodiment will be omitted. An object 65-7b indicating information such as horizontal lines, vertical lines, altitude, speed, and glide scope may be displayed on the primary flight display 65b of the UAM aerial vehicle of this embodiment. In addition, an object 65-8b indicating the UAM aerial vehicle may be displayed on the primary flight display 65b so that the attitude of the UAM aerial vehicle may be intuitively known through the above-described object 65-7b.

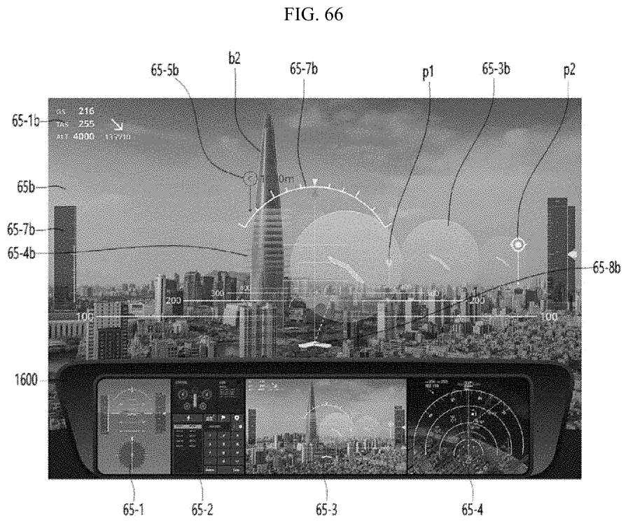

FIGS. 66 to 71 are diagrams illustrating a method of displaying a UAM flight-related event guidance object according to the fifth embodiment of the present disclosure.

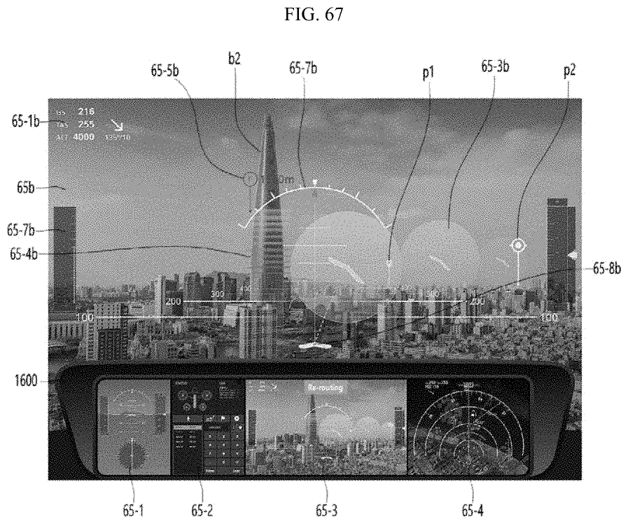

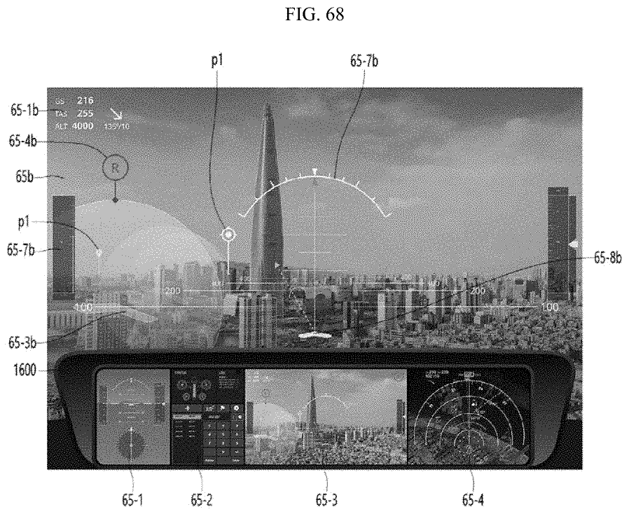

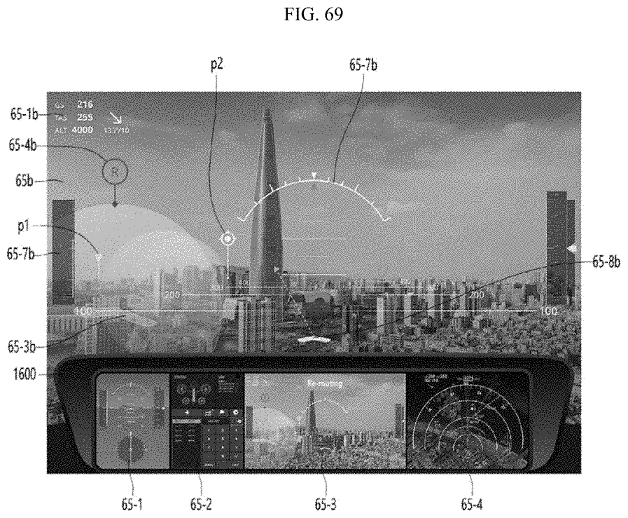

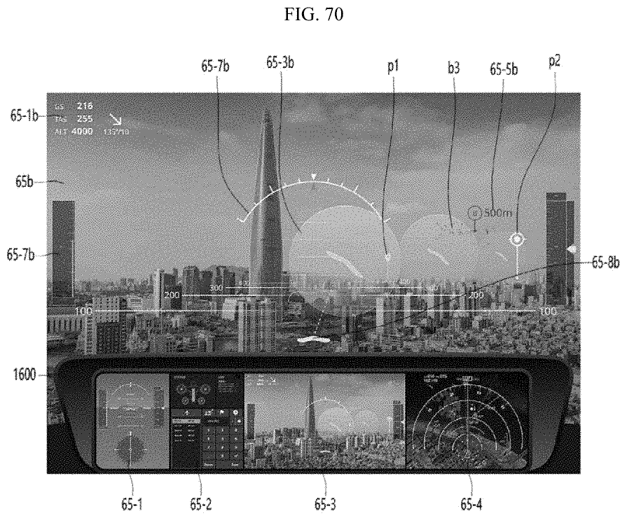

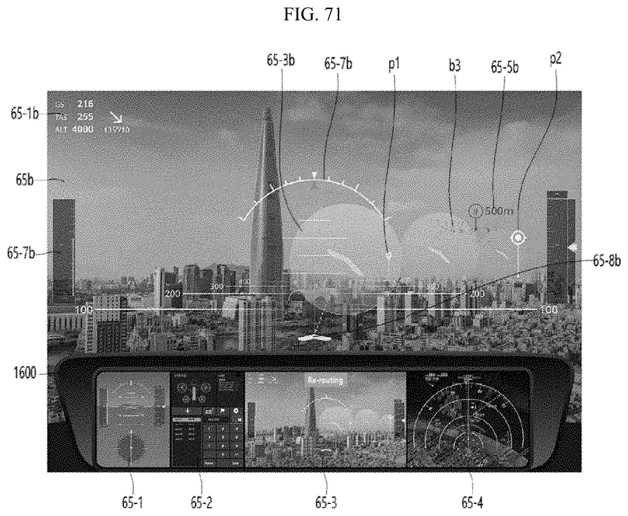

More specifically, FIGS. 66 and 67 are diagrams illustrating AR object display methods when a building is located on a flight route, and FIGS. 68 and 69 are diagrams illustrating the AR object display method when the UAM aerial vehicle deviates from a flight route, and FIGS. 70 and 71 are diagrams illustrating an AR object display method when there is a risk of bird strike due to a bird existing on a flight route.

As illustrated in FIG. 66, when a building p2 exists on the flight route of the UAM aerial vehicle, the UAM flight-related event guidance object 65-4b generated through the output data generation unit 613 may be displayed on the primary flight display 65b. The event identification object 65-4b may be displayed on a part of the building p2 interfering with the flight route of the UAM aerial vehicle. Also, an object 65-5b indicating a distance to a building and/or a height of the building may be displayed on the primary flight display 65b.

As illustrated in FIG. 67, the AR route guidance object 65-3b may be displayed in a different color from when an event does not occur in order to intuitively inform the pilot and/or passengers whether the event has occurred.

Meanwhile, as illustrated in FIG. 68, when the UAM aerial vehicle deviates from the flight route, the icon-shaped UAM flight-related event guidance object 65-4b generated through the output data generation unit 613 may be displayed on the primary flight display 65b.

As illustrated in FIG. 69, the AR route guidance object 65-3b may be displayed in a different color from when an event does not occur in order to intuitively inform the pilot and/or passengers whether the event has occurred.

Meanwhile, as illustrated in FIG. 70, when there is a risk of bird strike on the flight route of the UAM aerial vehicle (b3), the object 65-5b indicating the distance to the point b3 where there is the risk of bird strike generated through the output data generation unit 613 may be displayed on the primary flight display 65b.

As illustrated in FIG. 71, the AR route guidance object 65-3b may be displayed in a different color from when an event does not occur in order to intuitively inform the pilot and/or passengers whether the event has occurred.

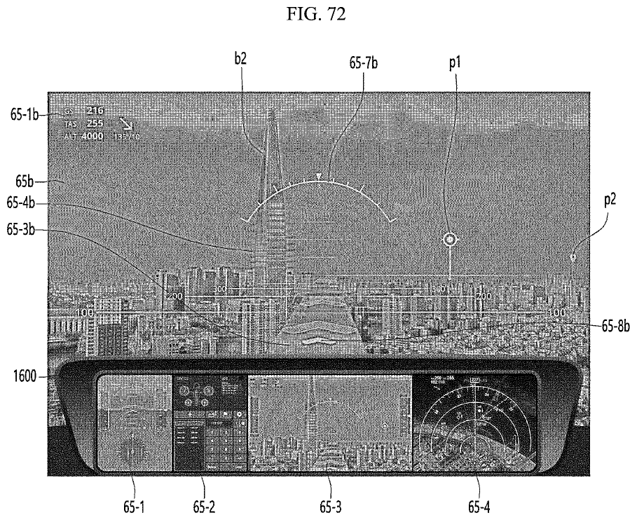

FIG. 72 is a diagram showing AR guidance objects displayed during flight of UAM aerial vehicle according to a sixth embodiment of the present disclosure, and each object is as described above.

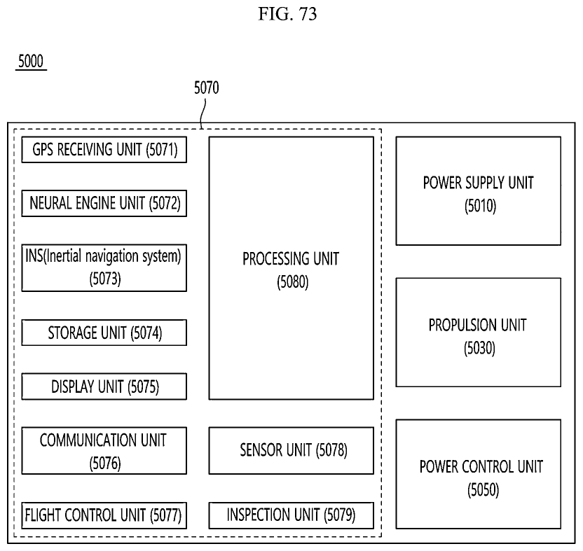

FIG. 73 is a block diagram illustrating an aerial vehicle according to an embodiment of the present disclosure. Referring to FIG. 73, a UAM aerial vehicle 5000 may include a power supply unit 5010, a propulsion unit 5030, a power control unit 5050, and a flight control system 5070.

The UAM aerial vehicle 5000 of this embodiment may include a propulsion unit 5030 including a plurality of propulsion units, and a fan module including an electric fan motor and a propeller may be applied as an embodiment of the plurality of propulsion units.

The fan module may receive power through the power supply unit 5010, and control of each of the plurality of fan modules may be performed through the power control unit 5050.

Also, the power control unit 5050 may selectively provide any one of power generated through an internal combustion engine and power generated through electric energy to the plurality of fan modules. More specifically, the power control unit 5050 may include a fuel storage unit, an internal combustion engine, a generator, and a battery unit. The fuel storage unit may store fuel required for the operation of the aerial vehicle.

The fuel required for an operation of an aerial vehicle may include taxi fuel required for taxiing on the ground, trip fuel required for one-time landing approach and a missed approach by flying from a departure point to a destination, destination ALT fuel required to fly from the destination to the landing point in case of a nearby emergency, holding fuel required to stay in flight for a certain period of time with the expected weight of the aerial vehicle at the landing point of the destination, additional fuel in case more fuel is required due to a failure of engine, and pressurizer, etc., contingency fuel additionally loading a certain percentage of trip fuel to prepare for an emergency, etc.

The above-described type of fuel is one type for calculating fuel required for the operation of the aerial vehicle, and is not limited to the above-described type, and as will be described later, the amount of fuel stored in the fuel storage unit may be determined by considering the overall energy required for the operation of the aerial vehicle to reach the destination from the departure point together with the battery unit.

The internal combustion engine may generate power to drive a power generation unit by burning fuel stored in the fuel storage unit, and the power generation unit may generate electricity using power generated by the internal combustion engine and provide the power to the propulsion unit 5030.

The battery unit may be charged by receiving power from the power generation unit or by receiving power from the outside.

More specifically, fuel may be stored in the fuel storage unit and power may be supplied to the battery unit to be charged in consideration of total thrust energy required for the aerial vehicle to perform a mission.

However, when it is necessary to charge the battery unit according to the change in flight route due to the off-nominal situation, the battery unit may be charged through the power generation unit as described above.

The power control unit 5050 may include a power supply path control unit, a power management control unit, and a motor control unit, and may be controlled through the flight control system 5007.

Here, the flight control system 5070 may receive a pilot's control, a pre-programmed autopilot program, etc., through the control signal of the flight control surface, and control the attitude, route setting, output, etc., of the aerial vehicle.

In addition, the flight control system 5070 may process control and operation of various blocks constituting the UAM aerial vehicle.

The flight control system 5070 may include all or part of a processing unit 5080, a GPS receiving unit 5071, a neural engine 5072, an inertial navigation system 5073, a storage unit 5074, a display unit 5075, a communication unit 5076, a flight control unit 5077, a sensor unit 5078, and an inspection unit 5079.

The processing unit 5080 may process various information and data for the operation of the flight control system 5070 and control the overall operation of the flight control system 5070. In particular, the processing unit 5080 may perform the function of the above-described apparatus 1000 for providing augmented reality guidance, and a detailed description thereof will be omitted.

The aerial vehicle may receive signals from GPS satellites through the GPS receiving unit 5071 to measure the location of the aerial vehicle.

The UAM aerial vehicle 5000 of this embodiment may receive information transmitted from control and base stations through the communication unit 5076. Examples of information transmitted from control and base stations may include weather information of a flight zone, prohibited area information, flight information of other aerial vehicles, etc., and information directly or indirectly affecting the flight route among the information received through the communication unit 5076 may be output through the display unit 5075.

The UAM aerial vehicle 5000 may perform communication with an external control base or other aerial vehicles through the communication unit 5076. For example, the aerial vehicle may perform wireless communication with other UAM aerial vehicles, communication with the UAM operation unit 154 or the PSU 102, communication with a vertiport management system, and the like through the communication unit 5076.

The storage unit 5074 may store information such as various types of flight information related to the flight of the UAM aerial vehicle, flight plan, flight corridor information assigned from the PSU or UAM operator, track ID information, UAM flight data, and map data. Here, the flight information of the UAM aerial vehicle stored in the storage unit 5074 may exemplarily include location information, altitude information, speed information, flight control surface control signal information, propulsion control signal information, and the like of the aerial vehicle.

In addition, the storage unit 5074 may store a navigation map, traveling information, etc., necessary for the UAM aerial vehicle 5000 to travel from a departure point to a destination.

The neural engine 5072 may determine the failure or possibility of failure of each component of the UAM aerial vehicle 5000 through pre-trained data, and the training data may be accumulated through comparison with preset inspection results.

The inspection unit 5079 may compare an inspection result value obtained by inspecting the system of the UAM aerial vehicle 5000 with a preset result value. The above-described comparison may be performed sequentially while matching the configurations of the power unit and the control surface with the preset result value, and the process or result thereof may be identified to the pilot through the display unit 5000.

The sensor unit 5078 may include an external sensor module and an internal sensor module, and may measure the environment inside and outside the UAM aerial vehicle 5000. For example, the internal sensor module may measure the pressure, the amount of oxygen, etc., inside the UAM aerial vehicle 5000, and the external sensor module may measure the altitude of the UAM aerial vehicle 5000 and the existence of objects around the aerial vehicle, etc.

The inertial navigation system 5073 may use a gyro to create a reference table that maintains a constant attitude in an inertial space and is configured to include a precise accelerometer installed thereon, and may measure the current location of the aerial vehicle by obtaining the flight distance through the acceleration during the operation of the UAM aerial vehicle 5000.

The flight control unit 5077 may control the attitude and thrust of the UAM aerial vehicle 5000. More specifically, the flight control unit 5077 may receive the propulsion power control signal, the flight control surface control signal, etc., from the control surface, the UAM operator 154, the PSU 104, or the like, and control the flight force/control surface of the UAM aerial vehicle.

In addition, the flight control unit 5077 may control the operation of the power control unit 5050. Specifically, the power control unit 5050 may include a power supply path control unit, a power management control unit, and a motor control unit, and the power supply path control unit may select at least one of the power generation unit and the battery unit to supply power to at least one of the plurality of fan modules.

As an example of supplying power to a plurality of fan modules, the power supply path control unit may select at least one of the power generation unit or the battery unit as a power supply source based on the power required to generate the thrust of the aerial vehicle, and then may be controlled to have the same RPM through RPM monitoring of the fan/propeller of the propulsion unit for generating the thrust.

In this case, the power supply control unit may monitor the status of the selected propulsion unit, determine whether there is a non-operating propulsion unit when an error occurs in any one of the selected at least one propulsion unit, and supply power by selecting the non-operating propulsion unit as an alternative propulsion unit when there is an inoperative propulsion unit.

In addition, when there is no non-operating propulsion unit, the power supply path control unit 651 may determine whether insufficient propulsion force can be offset by increasing the RPM of the propulsion unit 631 in normal operation, and if the offset is possible, supplement the insufficient thrust by controlling the propulsion unit in the normal operation, and perform an emergency landing procedure if offset is not possible.

The power management control unit may calculate thrust, power, energy, etc., required for the aerial vehicle to perform a mission, and determine power required for the power generation unit and the battery unit based on the calculated thrust, power, energy, etc.

The motor control unit may control lift, thrust, etc., provided to the aerial vehicle by controlling the fan module.

Meanwhile, the display unit 5075 may display the above-described various augmented reality guidance screens like the display unit 65 of the above-described apparatus 1000 for providing augmented reality guidance.

Meanwhile, the methods according to various exemplary embodiments of the present disclosure described above may be implemented as programs and be provided to servers or devices. Therefore, the respective apparatuses may access the servers or the devices in which the programs are stored to download the programs.

In addition, the methods according to various exemplary embodiments of the present disclosure described above may be implemented as programs and be provided in a state in which it is stored in various non-transitory computer-readable media. The non-transitory computer-readable medium is not a medium that stores data therein for a while, such as a register, a cache, a memory, or the like, but means a medium that semi-permanently stores data therein and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

According to various embodiments of the present disclosure, it is possible to intuitively display a traveling route to a pilot.

According to various embodiments of the present disclosure, it is possible to provide flight instrument information simultaneously with a traveling screen.

According to various embodiments of the present disclosure, it is possible to confirm a degree of deviation from a designated route with information such as color.

According to various embodiments of the present disclosure, it is possible to confirm an emergency route to a safe zone in case of an emergency.

According to various embodiments of the present disclosure, it is possible to provide conditions of a current traveling course using color of a route line.

According to various embodiments of the present disclosure, it is possible to intuitively provide a degree of deviation from a traveling route using transparency of a route line.

The effects of the present disclosure are not limited to the above-mentioned effects, and other effects that are not mentioned may be obviously understood by those skilled in the art from the following description.

Although various embodiments of the present disclosure have been disclosed for illustrative purposes, those skilled in the art will appreciate that various modifications, additions and substitutions are possible, without departing from the scope and spirit of the present disclosure as disclosed in the accompanying claims. Accordingly, the scope of the present disclosure is not construed as being limited to the described embodiments but is defined by the appended claims as well as equivalents thereto.

1. A method of providing augmented reality guidance for an aerial vehicle, comprising:
acquiring an aerial vehicle flight image captured through a camera installed in the aerial vehicle;
acquiring a flight route for a flight to a destination of the aerial vehicle;
generating an augmented reality (AR) route guidance object corresponding to the flight route;
generating an AR route guidance image by mapping the generated AR route guidance object to the aerial vehicle flight image; and
displaying the generated AR route guidance image.

2. The method of claim 1, wherein the acquiring of the aerial vehicle flight image includes:
calculating a tilt direction slope value during the flight of the aerial vehicle; and
correcting a tilt direction slope of the camera so that the camera keeps level based on the calculated slope value.

3. The method of claim 1, wherein the AR route guidance image further includes an object indicating a slope of the aerial vehicle in yaw, pitch, and roll directions.

4. The method of claim 1, further comprising comparing a location of the aerial vehicle with the flight route to determine whether the aerial vehicle deviates from the route, wherein, in the displaying, the AR route guidance object is displayed differently depending on whether the aerial vehicle deviates from the route.

5. The method of claim 4, further comprising calculating a degree of the deviation from the route when the aerial vehicle deviates from the route,
wherein, in the displaying, the AR route guidance object is displayed differently depending on the degree of the deviation from the route.

6. The method of claim 1, further comprising determining a risk of the flight route based on dynamic hazard information mapped to flight map data of the aerial vehicle, wherein the dynamic hazard information includes at least one of weather information, bird flock information, and other aerial vehicles information.

7. The method of claim 6, further comprising determining a risk level by applying a weight to the hazard information,
wherein, in the displaying, the AR route guidance object is displayed differently depending on the risk level.

8. (canceled)

9. The method of claim 1, further comprising, when an altitude of the aerial vehicle is out of a reference altitude range, generating an AR altitude danger guidance object indicating altitude danger,
wherein, in the displaying, the generated AR altitude danger guidance object is displayed on the AR route guidance image.

10. The method of claim 1, further comprising, when an event is detected from the aerial vehicle flight image during the flight of the aerial vehicle, identifying a type of the event,
wherein, in the displaying, an AR event guidance object indicating the event according to the identified type of the event is displayed on the AR route guidance image.

11. The method of claim 10, wherein the event includes at least one of a bird flock event, a collision risk building, a vertiport, and a prohibited area.

12. The method of claim 1, wherein, in the generating of the AR route guidance object, an AR route guidance object composed of a plurality of objects is generated, and the AR route guidance object is generated by adjusting an arrangement interval of the plurality of objects according to whether the route is a curve route or a straight route.

13. The method of claim 12, wherein the generating of the AR route guidance object includes:
calculating an image distance to a point where the plurality of objects are displayed based on a viewpoint of the aerial vehicle; and
adjusting vertical heights of each of the plurality of objects according to the calculated image distance.

14. The method of claim 1, wherein the AR route guidance image includes at least one of:
a first AR route guidance image displaying the AR route guidance object on a forward image that is transmitted through a windshield of the aerial vehicle and shown to a passenger, and
a second AR route guidance image displaying the AR route guidance object in the captured aerial vehicle flight image shown to the passenger through a screen

15. (canceled)

16. A computer-readable recording medium in which a program for executing the method of providing augmented reality guidance, wherein the method comprising:
acquiring an aerial vehicle flight image captured through a camera installed in the aerial vehicle;
acquiring a flight route for a flight to a destination of the aerial vehicle;
generating an augmented reality (AR) route guidance object corresponding to the flight route;
generating an AR route guidance image by mapping the generated AR route guidance object to the aerial vehicle flight image; and
displaying the generated AR route guidance image.

17. An apparatus for providing augmented reality guidance, comprising:
an image acquisition unit installed in an aerial vehicle to acquire a flight image of the aerial vehicle;
a flight route determination unit generating a flight route for a flight to a destination of the aerial vehicle;
an AR guidance object generating unit generating an augmented reality (AR) route guidance object corresponding to the flight route;
an AR guidance image generation unit generating an AR route guidance image by mapping the generated AR route guidance object to the aerial vehicle flight image; and
a display unit displaying the generated AR route guidance image.

18-19. (canceled)

20. The apparatus of claim 17, wherein the flight route determination unit compares a location of the aerial vehicle with the flight route to determine whether the aerial vehicle deviates from the route, and
the display unit displays the AR route guidance object differently depending on whether the aerial vehicle deviates from the route.

21. (canceled)

22. The apparatus of claim 17, wherein the flight route determination unit determines the risk of the flight route based on dynamic hazard information mapped to flight map data of the aerial vehicle, and
the dynamic hazard information includes at least one of weather information, bird flock information, and other aerial vehicles information.

23. The apparatus of claim 22, wherein the flight route determination unit determines a risk level by applying a weight to the hazard information, and
the display unit displays the AR route guidance object differently depending on the risk level.

24-25. (canceled)

26. The apparatus of claim 17, further comprising, when an event is detected from the aerial vehicle flight image during the flight of the aerial vehicle, an event identification unit identifies a type of the event,
wherein the display unit displays an AR event guidance object indicating the event according to the identified type of the event on the AR route guidance image.

27. (canceled)

28. The apparatus of claim 17, wherein the AR guidance object generation unit generates an AR route guidance object composed of a plurality of objects, and generates the AR route guidance object by adjusting an arrangement interval of the plurality of objects according to whether the route is a curve route or a straight route.
